(19) United States
(12) Patent Application Publication
(10) Pub. No.: US 2015/0081579 A1
(43) Pub. Date: Mar. 19, 2015

(54) SYSTEM FOR CONVEYING DATA TO RESPONDERS AND ROUTING, REVIEWING AND APPROVING SUPPLEMENTAL PERTINENT DATA

(71) Applicant: Prepared Response, Inc., Kirkland, WA (US)

(72) Inventors: Michael G. Brown, Kirkland, WA (US); James W. Finnell, Kirkland, WA (US)

(21) Appl. No.: 14/469,447

(22) Filed: Aug. 26, 2014

Related U.S. Application Data
(60) Provisional application No. 61/869,997, filed on Aug. 26, 2013.

(51) Int. Cl. G06Q 50/26; H04W 4/02; H04W 4/22; G06F 17/30

(52) U.S. Cl. CPC G06Q 50/265; G06F 17/30498; H04W 4/02; H04W 4/22
USPC 705/325

(57) ABSTRACT

Techniques are described herein to converge and conditionally filter data and to present such data in a manner that is beneficial to situational data analysis, in association with emergency management, law enforcement, or other such situations. Data may be combined to create enhanced situational awareness for responders and improve their decision making ability.

### RELATED APPLICATIONS

This application claims the benefit of priority to U.S. Provisional Patent Application No. 61/869,997, filed Aug. 26, 2013 which is incorporated herein by reference.

### BACKGROUND

The present disclosure relates to the availability of key information in the conduct of real-time decision making for fire service, law enforcement, emergency medical service, government officials, and emergency managers. There are many reasons that critical information is not able to be employed by responders in the conduct of real-time decision making. In some cases, the information exists but is not accessible to responders, or access is not achieved in a timely fashion. Alternatively, a network such as the Internet or other data sources can create a situation where responders are presented with such great volumes of information that they are unable to sort and filter the content into discrete and actionable data objects. In yet other instances, useful data sets may exist, but they reside in separate repositories which are unaware of one another. This condition prevents complex data interactions, thus denying subscribers from obtaining critical insights. For example, during a flooding situation, first responders may wish to evacuate all nursing homes in danger of flooding. To accomplish this task, those first responders may need to identify areas of low elevation and locations of all nursing homes. If these data sets reside in different locations and are not interoperable, the first responder is without a method to efficiently identify locations at risk and deploy resources to address the incident.

Additionally, there are cases where several agencies may have multiple interactions at those locations thus creating a series of non-interoperable data stores associated with that location. In such cases, one organization may operate on a certain set of information (some of which may be gathered directly by that organization, but not shared) while another organization might operate on a different set of information (which again may be developed through experience with that location. For example, a state child welfare organization and law enforcement may have reason to interact with different situations occurring at the same location. The child welfare organization may be aware that a foster child resides at a location while a law enforcement organization may be seeking to serve a warrant at the same location. Without interoperable data, neither organization may have a complete understanding of the special situations that might apply to that location.

In each of the examples described (i.e., the presence of too much data, too little data, or non-interoperable data), responders are at a disadvantage because they may lack a reliable a mobile or portable data source and a system to index, sort, filter and present salient content in a time efficient fashion. Further, where information changes on a more frequent basis than can be monitored, the decision maker is further placed at a disadvantage and may make sub-optimal decisions due to a lack of information or based on out-of-date information. This particularly may be the case when decisions require input from rapidly changing data types such as weather; natural conditions (e.g., river flow or stage), and input from other sensors as described herein. This disadvantage that may occur as a result of inaccurate, unavailable, or overwhelming information places responders at elevated risk when approaching an area unfamiliar to them or when conditions change rapidly.

### BRIEF SUMMARY

Embodiments of the present invention provide a method for converging and filtering data and for presenting such data in a manner that is beneficial to situational data analysis, in association with emergency management, law enforcement, or other such situations. By converging and conditionally filtering government maintained data, public data and selected privately held data, it may be possible to create enhanced situational awareness for responders that otherwise may not be available, thus impacting their decision making. Data may also be automatically queried and presented based on the positional information of the subscriber and/or other situational conditions. For example, the spatial location of a responder may be used to query the data for information relevant to that spatial location. In such an example, the position of a user may be constantly polled and passed into a geographical database where information corresponding to the subscriber's requirements and access levels, and based at least in part on the location, may be presented to the user. Those conditions suggesting a potentially dangerous condition or that meet configurable parameters may be pushed directly to the subscriber with an alert such as an audio alert, a visual alert, a vibration alert or a combination of these and/or other alerts. Such a system may additionally intake information associated with a particular location based on, for example, field observations. Existing data may then be verified, edited, or new information may be added thus allowing the converged database to adapt and/or be self-correcting.

The following detailed description together with the accompanying drawings will provide a better understanding of the nature and advantages of the present invention.

### BRIEF DESCRIPTION OF THE FIGURES

Various embodiments in accordance with the present disclosure will be described with reference to the drawings, in which:

FIG. 1 illustrates an environment where data associated with the system is stored in accordance with an embodiment;

FIG. 2 illustrates a pertinent warning tables in accordance with an embodiment;

FIG. 3 illustrates a sensor table in accordance with an embodiment;

FIG. 4 illustrates an data table in accordance with an embodiment;

FIG. 5 illustrates an organizational schematic for the system in accordance with an embodiment;

FIG. 6 illustrates a physical system in accordance with an embodiment;

FIG. 7 illustrates an data flow diagram in accordance with an embodiment;

FIG. 8 illustrates a data correlation in accordance with an embodiment;

FIG. 9 illustrates a relation of correlated data in accordance with an embodiment;

FIG. 10 illustrates a relation of correlated data in accordance with an embodiment;

FIG. 11 illustrates an environment where a map and alert display associated with the system is displayed in accordance with an embodiment;

FIG. 12 illustrates a data handling process in accordance with an embodiment;

FIG. 13 illustrates a process for conveying special instructions in accordance with an embodiment;

FIG. 14 illustrates an arrangement of data nodes in accordance with an embodiment;

FIG. 15 illustrates an arrangement of data nodes in accordance with an embodiment;

FIG. 16 illustrates a process for data recursion in accordance with an embodiment;

FIG. 17 illustrates a device registration in accordance with an embodiment;

FIG. 18 illustrates a display of a custom icon in accordance with an embodiment;

FIG. 19 illustrates a data gathering process in accordance with an embodiment;

FIG. 20 illustrates a flagged term table in accordance with an embodiment;

FIG. 21 illustrates a process for routing data in accordance with an embodiment;

FIG. 22 illustrates a data schematic in accordance with an embodiment;

FIG. 23 illustrates flagged term routing tables in accordance with an embodiment;

FIG. 24 illustrates tag routing tables in accordance with an embodiment;

FIG. 25 illustrates a hierarchical routing table in accordance with an embodiment; and

FIG. 26 illustrates an environment in which various embodiments can be implemented.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques described and suggested herein include methods, systems, and processes to converge and conditionally filter data and for presenting such data in a manner that is beneficial to situational data analysis, in association with emergency management, law enforcement, or other such situations. Data may be combined to create enhanced situational awareness for responders thus improving their decision making ability. Such data may be based on the positional information of the subscriber and/or other situational conditions. Those conditions suggesting relevant conditions may be sent to the users of the system. The system may additionally correlate information associated with a particular location to further improve situational data analysis.

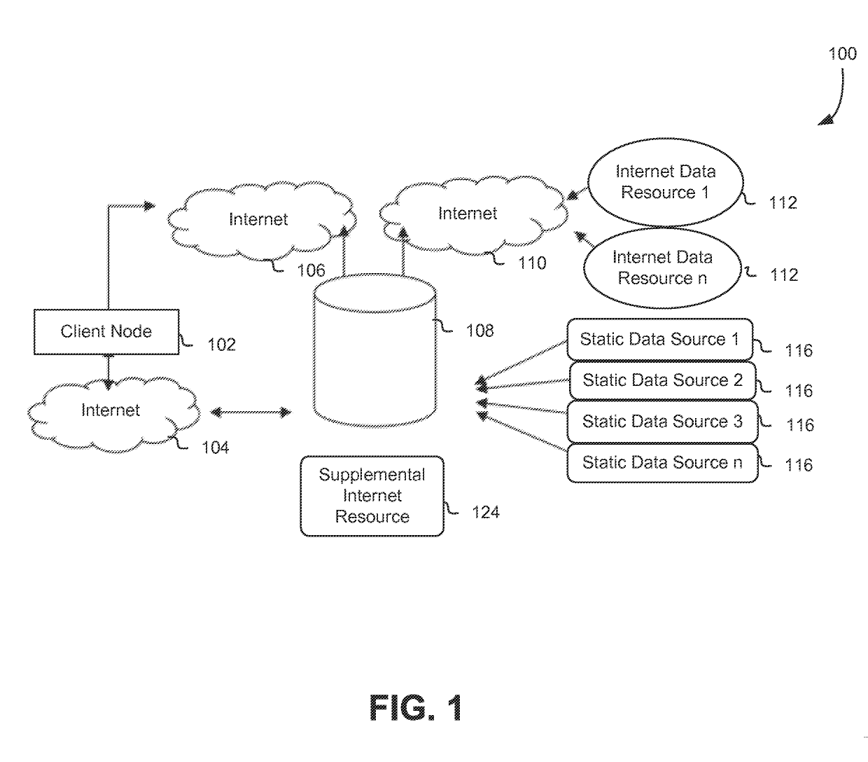

FIG. 1 illustrates an example environment 100 where data associated with a system for conveying data to responders and routing, reviewing and approving supplemental pertinent data is illustrated in accordance with an embodiment. A client node 102 may connect to a database 108 via a network connection to a network such as the Internet 106. The client node may also connect to one or more supplemental internet resources 124 via a network connection to a network such as the Internet 104. As used herein, and unless otherwise made clear by context, “Internet” may refer to any network capable of providing network transport of data packets. Internet data resources 112 (as described herein) may also connect to the database 108 via a network connection to a network such as the Internet 110. One or more static data sources 116 may also connect to the database 108.

Various examples illustrating the data flow of data associated with the system for conveying data to responders and routing, reviewing and approving supplemental pertinent data are described herein. For example, data utilized in the claimed system will reside on either the database server or will be queried dynamically from resources on the Internet. As shown in FIG. 1, static data may be loaded in the database from one or many static sources in advance of a query from the client. The static data sources may include, but may not be limited to assessor data, voter registration data, inventories of hazardous materials, sex offender residences, or business licenses. Data may be accessed from sources from network-based sources. In some embodiments, the database or associated processing layer contacts data stores that are located in a separate location from the data base 108. Such external accesses may request data from the supplemental internet resource 124 (also referred to herein as “internet data resources”), which may provide data that is not stored in the database 108 and/or data that is more current than the data which may be stored in the database 108. When drawing from internet data resources, the claimed system will form a query to those resources based on the Internet Protocol address (“IP address”) and associated identifiers or query parameters which allow the internet data resources to search for and return data that matches search criteria.

In some embodiments, the claimed system will furnish the client node with the server-provided web page which allows the client to directly query for certain content (e.g., internet data resources). A variety of network content may be obtained directly from the client node using a uniform resource locator (“URL”) embedded in an hypertext markup language (“HTML”) anchor tag such as, for example, an image. Another example is a set of map tiles which may be rendered in open layers. In this example, a page loaded onto a client node may first pass a position (e.g. latitude and longitude) and/or extents for which the client requested content to the supplemental internet resource 124. If available, the supplemental internet resource 125 may then return a series of map tiles which may then reassembled and displayed on the client's computer as described herein. Using the page furnished by the system, the client may also request information from the database which might, in turn, query internet data resources for other data not resident in the database 108. Data from one or more locations may then combined and passed back to a client device where the information may be displayed.

As described herein, the dual indexing of the buildings (e.g., by civic address and/or geographic position) may be achieved by loading static data from the county assessor and other government and commercial sources into the database. If the loaded address data lacks geoposition data, the data may be geocoded using a variety of techniques and/or services. The data sets may have multiple indices such as, for example, buildings may be indexed by geographic position, address, or owner. Phone data may be indexed by name, address, or phone number. Voting records may be indexed by name or address.

Various issues associated with data related to certain data types or conditions are described herein. For example, with respect to sex offender data, the location of registered sex offenders is often reported inaccurately. Without enhanced data analysis or door to door verification, there is little added accuracy that can derived by examining the sex offender data in isolation. However, by comparing the reported location of sex offenders to other government data and commercial data, a probabilistic assessment can be developed as to if the offender truly lives at reported address. For example, after adding sex offender's name and associated address to a database, a query of phone records can be conducted to see if that person appears at the same address in an unrelated, commercially maintained database. If there is ever divergence between the two records (sex offender registry and commercial phone record), authorities who may have interest in verifying the address of the sex offender would have reason to investigate further.

With respect to at-risk populations which may experience elevated levels violence, neglect, or related circumstances, the automatic correlation of a responder's location to a database of potentially at-risk persons may provide emergency personnel with an added level of awareness when responding to a call for service or conducting business in an unrelated case. For example, if law enforcement officials enter a house for a domestic disturbance, they may also use associated data to check on the well-being of a foster child which may be registered to that same address.

In responding to calls, emergency workers may benefit from understanding that a parolee may be present. Due to high recidivism rates for certain crimes, an understanding of an occupant's history may lead one to be on the lookout for indications of a subsequent crime. For instance, a theft conviction may carry with it a high recidivism rate. Thus when entering the residence of a person convicted of theft, should certain items appear out of place, there may be reason to further consider the observed facts.

Arrest warrants and other court orders may take time to disseminate and may not always be shared efficiently between agencies and/or jurisdictions. Local law enforcement officers may approach a location for which a federal warrant exists with additional care. Likewise, a non-law enforcement responder may be called to the location of a wanted person. By converging federal, state and/or local information regarding wants and/or warrants into a single, geographically-aware database, a user may be alerted if they are at or near a location that is associated with wants and/or warrants.

Personnel who interact with the public in general (and first responders in particular) may face a variety of hazards. The nature, location, and number of such hazards may change on an ongoing basis, possibly impacting officer safety. Certain hazards may place the officer at risk if they close to, for example, within 100 meters while other hazards may only be an issue if the officer is, for example, within 5 meters. A person who has demonstrated aggressive behavior toward law enforcement personnel may be armed and thus pose a potential hazard at long distances. An aggressive dog, on the other hand, may only pose a threat within a fence-line. In order to make personnel aware of threats and allow them to take prudent precautions based on the nature of those threats, a database of potential threats and their associated threat distance may be correlated real-time with a person's position. When a person closes within the threat radius of a given hazard, an audible, visual, tactile, or other sensory alert may be rendered, presenting information on the threat as well as precautionary measures needed to mitigate the threat.

The nature of a building, structure, or location and its occupants may modulate emergency response. For example, if a licensed home daycare center is known to be at the location of an emergency call for assistance, the number and nature of the responders dispatched is likely to be elevated over that of a typical response. While the location and character of large institutions may be well known, smaller business located in a residential setting may not be known or may not be well understood. Thus, using business licensing data, department of health records and related descriptive data, the claimed system may make known to responders residential locations where vulnerable citizens may be located.

There are many sites for which there is a history or registration of on-site chemicals and discharges. Such registries may exist at the federal, state and local level but often not be correlated to one another. There also may be no indication as to whether such sites have such a history or what considerations might be present should that site be involved in a disaster such as a fire, a flood or other destructive event which might release or dislodge chemicals or materials that may be hazardous to humans or the environment. The system described herein may geolocate (i.e., locate within a spatial database) each cataloged address using available identifiers and subsequently may identify sites where, for example, multiple records may identify a single site or where multiple neighboring sites might undergo an event which would comingle materials. This information may be made available to responders with access to the original data as well as additional resources which may provide supplemental information such as material safety data sheets, references to physical properties, or guidance for the handling of hazardous materials.

An emergency response may be modified if it may involve people with special needs. In cases where a responder knows or should know that the situation involves a special needs person (i.e., a person with communication or cognitive challenges), certain methods and de-escalation techniques may be utilized. The system described herein may have the ability to flag the presence of a special needs person and may also provide imagery to assist in the identification of the person, provide detailed instruction as to best practices as to how best to handle a situation, information related to care givers or trusted persons, and/or other such information. The system may accommodate a variety of data inputs including information retained at a state and local level as well as information entered by persons such as the specials needs individual and/or a care giver.

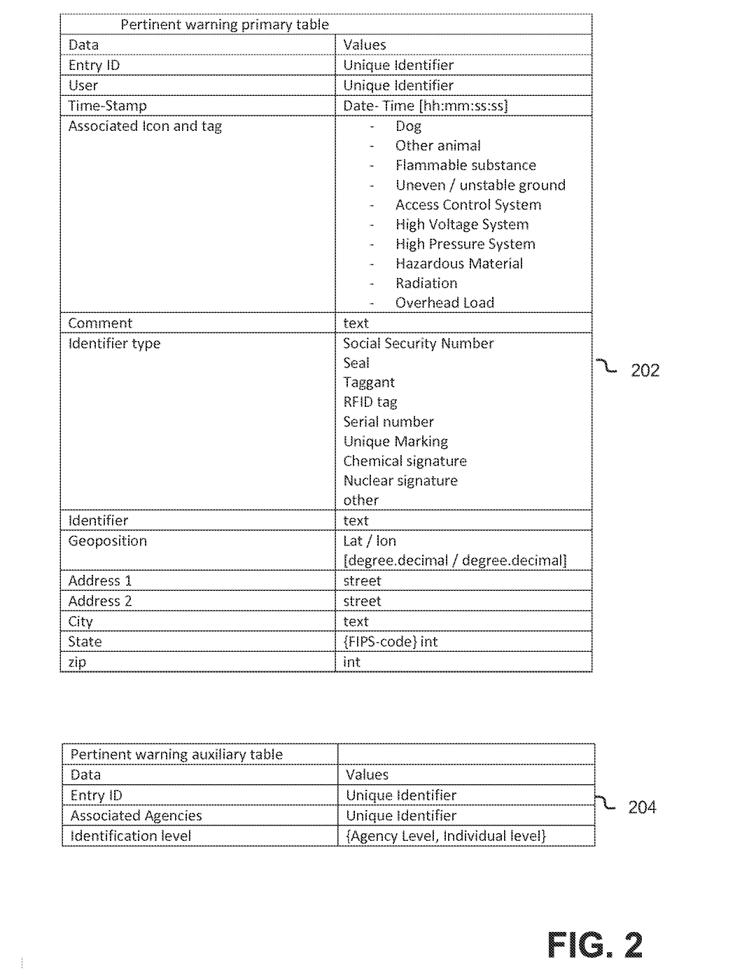

FIG. 2 illustrates an example pertinent warning primary table 202 and an example pertinent warning auxiliary table 204 in accordance with an embodiment. The system described herein may inventory known and documented structures, persons, and objects. In cases where a structure's position is static, a location may be geocoded based on the address, referenced from assessor data, or input directly from positioning devices. Objects such as shipping containers, hazardous waste, nuclear materials, weapons or any other object that might be of interest may be recorded at an initial address and referenced to a geographic position (e.g., latitude and longitude), and may be further defined by a serial number, marking, seal, radio frequency identification tag, taggant (e.g., a radio frequency chip), or other such identifiers. Subsequent positions may be recorded in the database (as would be in the case of shipping or transporting of such objects). Lists of persons, their residences, and other identifiers (e.g., on-line aliases, usernames, email addresses, and phone numbers) may be sourced from a variety of records including, but not limited to, voting records, web searches, phone records, credit reports, and other government, commercial and privately maintained databases. The system described herein may reach across multiple agencies and authorities and may have the ability to converge (or combine) multiple descriptions of a single object from one or more agencies into a single entry. The entry and associated descriptions) may be tagged for source (user and agency inputting the data) as well as a time stamp which may allow analysis of time-sensitive data.

In order to avoid ambiguities associated with written language, the inputs may include Boolean elements, drop-down selectors, an icon driven menu, and other such user interface elements. Each icon may have a meaning that reduces ambiguity. Thus, a dangerous dog may have an icon and may not have a text description as an initial presentation. Should a user of the system wish to amend or modify supplementary text, an administrative interface may be presented which may allow those with sufficient permissions to modify the text. Users may elect to converge text and descriptors from a single agency or from multiple agencies. Input text may also be shared or marked as private to a particular agency, thus controlling the flow and exposure of information and maintaining the integrity and privacy of information consistent with controlling law and policy. Further, access to each data element or text may be recorded such that overseeing authority can audit for appropriate usage and disclosure of selected data.

Data entered as a field observation of pertinent data may have a temporal component. For instance a hazard at a particular location may not exist in perpetuity. The verification of field observations on a set periodic basis may be both time consuming and costly. Using a variety of data already stored and updated in the claimed system, it may be possible to draw inferences as to whether the field observations remain valid. For example, if a location was observed to have an aggressive dog, and the ownership of that location changes in the future, there may be an inferred basis to suspect the dog may no longer be at that location. Using tax assessor and sales data, the name of the owner may also be recorded at the time the original comment is entered. The system may then periodically and/or automatically poll current data to find evidence of ownership change. On detecting a different owner (e.g., the current owner is not the same as the owner at the time of the original entry) the system may alert administrators of the need to verify conditions at the commented location. Using this approach, the system may significantly reduce the resources dedicated to the verification of data on an arbitrary basis, and may focus updates based on data changes.

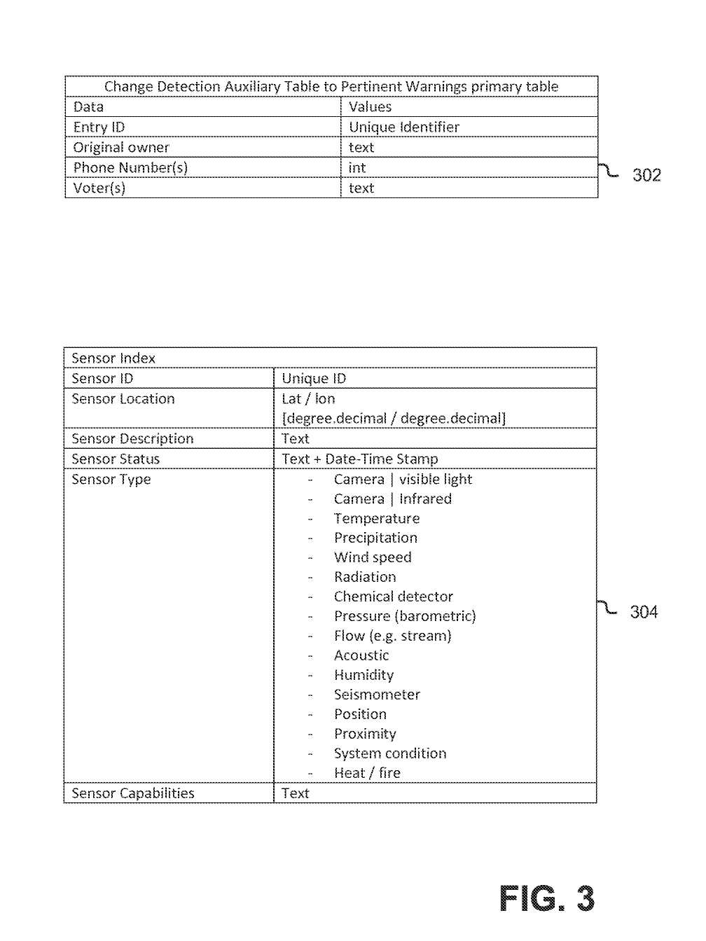

FIG. 3 illustrates an example change detection auxiliary table to pertinent warnings primary table 302 and an example sensor index table 304 in accordance with an embodiment. Users may report their position in the claimed system either by enabling positioning services (or the like) or by entering a geographic position which can occur by manually entering the position or selecting a position from a map. The reported position is used to push alerts (e.g., within 500 yards of a location know to be the last position of a wanted person) to the user interface of the claimed system. The user may also elect to make his or her position known to others within his or her agency, to a selected set of agencies, or to all who have appropriate system access. The user may also elect to make his or her identity known to others or simply report the agency he or she represents. The display granularity provides for sharing an identity with one or more agencies with the user's agency, and/or with users in one or more other agencies. For example, a user in agency “A”, can set his or her identity for a user in agency “B” to appear as “Agency A” or as “Officer Bob Smith, Agency A”. A different user in Agency “A” may set different identification levels. The identification levels may be set at a user or agency level such that an agency administrator may set each of its user's identification level at individual (e.g., “Office Bob Smith”) or agency (e.g., “Central City Police”). Using the positioning data, users may observe the location of other users and resources thus effectively and efficiently self-synchronizing position as opposed to communicating on the radio or other devices individually.

A resource (e.g., a person, a group of people, equipment, or supplies) may be located and its position tracked through the repeated reporting of its position. In this way, decisions regarding the staging of resources, accessing resources or the flow of resources may be managed. Furthermore, the resources may be tracked over time as well as restricted to a determined area, thus alerting users if the tracked object has moved from its intended position. Such a system may apply to either a static location or a moving space or volume including awareness as to the resource position relative to its assigned space.

The system may accommodate receipt of data feeds to advise of specifically requested conditions, their severity, and the area affected. Such data feeds may include areas affected by (or that may be affected by) flooding, tornado, tsunami, power outage, snow, public health emergency (e.g., pandemic influenza) and other such conditions.

The system may allow one or many objects to be tracked (as previously described) and to may also assign a position (e.g., latitude and/or longitude) to the object. The object's position may be further associated with a shape (one dimensional, two dimensional or three dimensional), which may vary in space and time. In the case where two or more shapes are changing, an alert may advise users of the condition when the geometries are in contact. Such a situation may occur in cases such as when two persons each have restraining orders against each other, or when a sex offender must remain a certain distance from a certain type of person or location, or when an alcoholic must remain a certain distance from one or more locations where liquor is available.

A reverse indexed sensor is a sensor which may provide a reference that allows a user to input a position of interest and obtain a list of those sensors which report conditions associated with the selected area. The system may converge all sensor sources such that public, government, private and geographically mobile sensors may be employed to ascertain conditions, support decision making and enhance situational awareness. The sensors may be organized both by location and type thus allowing for simple network status checks by querying device in a location of interest or accessing data for subsequent analysis. An example sensor table 304 is illustrated in FIG. 3.

Using a series of sensors and position inputs, the system may sample for specific criteria and alert the closest appropriate user of conditions associated with those sensors. Sensors may include sensors associated with rapidly changing data such as, for example, weather sensors, sensors for other natural conditions (e.g., river flow or stage), radiation sensors, biological sensors (e.g., for anthrax or other biological sensors), biological assay sensors, temperature sensors, pressure sensors, video monitors and/or sensors, telemetry sensors, accelerometers, telecommunications network sensors, utility grid sensors, transportation sensors, network (i.e., the Internet) sensors, positional sensors (e.g., from GPS or WiFi), medical status sensors, public health information, environmental condition information, traffic sensors, highway system monitors, and/or other such sensors. For example, a network of license plate readers may sample and record the license plates of cars passing each sensor. If a license plate correlates to a stolen vehicle, the system may reference the geographic location of the sensor and the position of the appropriate user that is closest to the stolen vehicle. Based on the position of the camera sensing the stolen car, the street characteristics at the location of the detection and the relative of the remaining camera network, the system may estimate the next acquisition of the stolen vehicle by other sensors. If a second camera detection is made, the claimed system may, for example, confirm average vehicle velocity and may then predict the time and location of the next detection as well as well as a predictive path based on, for example, dead reckoning. The system may further correlate subsequent detections and/or when further predicted detections do not occur as projected, which may suggest a change in the vehicle's path.

As described herein, positional data may include a description of static content, such as a building, as well as a description of dynamic content such as a user's position over time. In some embodiments, positional information may be privileged (i.e., the home addresses of all those receiving government benefits or the current position of a police officer).

In order to protect data from release, ensure integrity of incoming data being stored, and create a relation between a user and a transaction or system action, the system may have the capability to identify each device, resource, or person accessing the system. Although a user may be described herein as a person, a user may be any object capable of manifesting itself physically and for which there exists a physical position. The object may be authenticated to the claimed system, but may not be configured to authenticate itself via a login. For example, a shipping container may have a device mounted on it which may, in turn, report its position to the claimed system. User identification may be achieved by authenticating a user to the claimed system using a unique identifier and a password. This authentication data may be passed to the claimed system over an encrypted connection. Such connection may be via a Secure Sockets Layer (“SSL”) connection. Once the data arrives at the claimed system, the unique identifier and the password may be passed into the database as described herein. For security, the password may be salted with a unique string and then may undergo a one-way cryptographic hash such that the hashed value may be compared with the stored value. If they match, the user may be authenticated and may be allowed to conduct actions and access content consistent with his or her profile. This authentication may provide for information assurance that may be configured to harden the system against the intentional injection of false data. The strong typing (i.e., matching unique user to a unique identifier) additionally may allow users to better classify and sort positional data with a higher degree of reliability.

Storage of real-time data for correlation with other data and events may be used to support after the fact analysis. For example, ad hoc sourcing of sensors and associated data resident on mobile devices which might be proximate to a location of interest may be used to support analysis. A pool of users may cast data into a pool on a volunteer basis in cases where such data may create additional clarity as to the incident at hand. For example, a device may be accessed if there was a need to survey ambient noise (as measured by a cell phone's resident microphone) in a particular area in real-time. Alternatively, a mobile device may support an application that always records sound. In cases where an impulse or gunshot-like waveform is detected, a section of the recording may be excerpted and cast into a data pool to include date-time stamp and device location. Similarly, if an onboard camera exists, it may be activated and images automatically uploaded to a central data repository. In cases where a low frequency waveform may be present, conversations and other high frequency signals which may be modulated onto the low frequency wave may be demodulated by sampling the mobile device microphone.

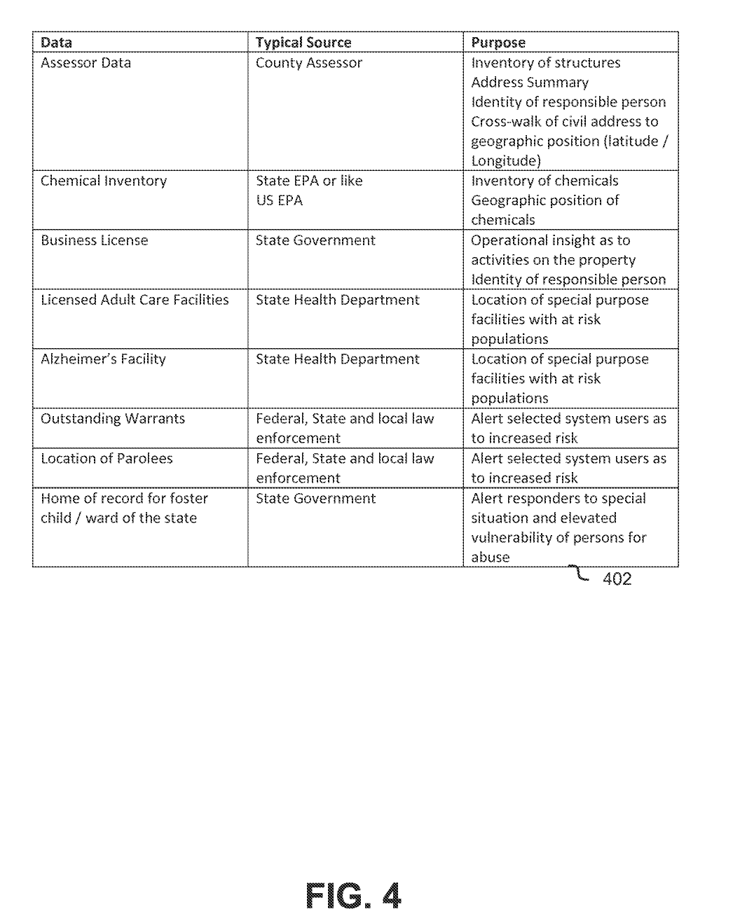

FIG. 4 illustrates an example data table 402 in accordance with an embodiment. The system may support several categories of data as described herein. For example, a corpus of trusted data may be supported within the claimed system. Trusted data is provided (generally in large quantities regarding broad regions) by reputable data sources such as federal, state, and local governments. The trusted data may be updated periodically and may serve as a foundation or framework for data positional queries that may be made to the system. Trusted data may additionally be added to the database in an ad hoc fashion (or unstructured) in cases where new, potentially unstructured, information may become available or known and the information is judged to have ongoing value for other users or agencies. Untrusted Data may also be added to the database. Untrusted data is content added to the system from, for example, unauthenticated users. On its own, the data may not be actionable, however if corroborated by other sources (trusted or not), the data may become actionable. For example, multiple untrusted independent observations may form the basis of a trusted event which may then be acted upon.

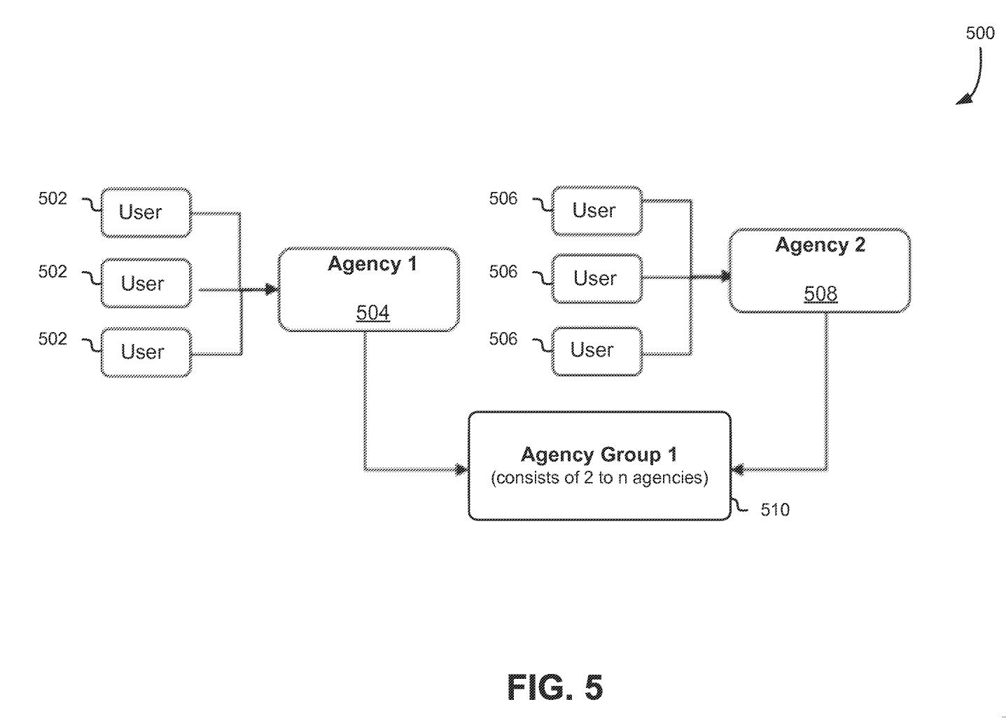

FIG. 5 illustrates an example organizational schematic 500 where users may be assigned to organizations in accordance with an embodiment. One or more users 502 may be assigned to an agency 504. The agency 504 is denoted “Agency 1” in FIG. 5. One or more other users 506 may be assigned to an agency 508. The agency 508 is denoted “Agency 2” in FIG. 5. Agencies such as agency 504 and agency 508 may be assigned to an agency group 510 that, in the example illustrated in FIG. 5, comprises a plurality of agencies. The agency group 510 is denoted “Agency Group 1” in FIG. 5.

In order to manage a user's profile and permissions, each user (unique identifier) may be assigned to an organization which, in turn may be sub-divided into sub-organizations. In this way, the sharing of positional information may be managed by an individual user, sub-organization, or organization. Groups of organizations may additionally be defined to allow sharing among logical groupings of organizations (e.g., all law enforcement organizations in a particular county may wish to share positional information with other organizations in the county). In order to accommodate users who wish to offer ad hoc content, sensors and other data, an additional category of organization (i.e., an unauthenticated category) may exit to accommodate self-reported and/or unverified organizations. Under this unauthenticated organizational structure, a user or series of users may self-identify their affiliation or may select no affiliation. Data and related content may be accepted from unauthenticated users, however, such data may be marked in the database as being from an unverified source and thus potentially less trustworthy.

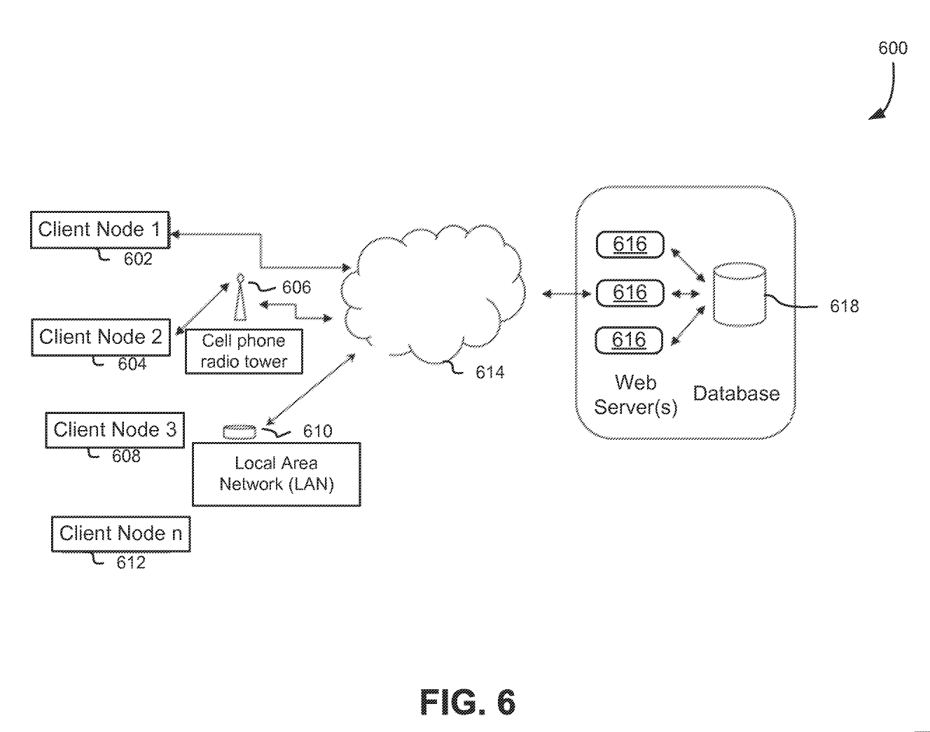

FIG. 6 illustrates an example physical system 600 where client nodes may be connected to the system in accordance with an embodiment. A client node 602 may connect via a network 614 to one or more servers such as the one or more web servers 616 illustrated in FIG. 6. The connection of the client node 602 to the network 614 may be via a network connection such as the Internet, as described herein. A client node 604 may also connect to the network 614 (and thus to the one or more servers) via a cellular network such as may be provided by a cell phone radio tower 606. A client node 608 may also connect to the network 614 (and thus to the one or more servers) via a local area network 610. The one or more servers such as the one or more web servers 616 illustrated in FIG. 6 may be connected to a database 618 as described herein.

The physical system 600 illustrated in FIG. 6 may consist of one or more clients (also referred to herein as “requesting nodes”), one or more interconnecting nodes, and a source node. The system may be accessed from a client node or nodes operating in variety of locations and configurations. The client node may be connected to the network 614 directly, or may transit through one or many intervening nodes to the network 614. Once on the network 614, requests and data exchange may be routed using, for example, Transmission Control Protocol and Internet Protocol (“TCP/IP”) and/or using secure sockets layer (“SSL”) transmission. The client nodes may be connected directly to the network 614 as shown in FIG. 6 or may be connected to the network 614 via some other transmission path including, but not limited to, a cell phone transmission path where the cell phone carrier transmits data bi-directionally on a radio network, which is in turn integrated to the network 614 at a point of presence. One or more clients may be connected to a local area network (“LAN”), which may in turn be connected to the network 614. The device type of the client node may include, but may not be limited to, a stationary desktop computer, a workstation, a portable computer, a tablet computer, a mobile device, a smart phone, or any other such device which may be configured to connect to the network 614. The device may typically be a commercial off-the-shelf computer with, for example, a 1 GHz processor, 1 GB random access memory (RAM) and a hard drive or solid state drive capable of storing 64 GB or more. The device may include an operating system, which may be, for example, Windows, Mac, Linux, a Linux variant (e.g., Ubuntu, Red Hat, SUSE, and others). The operating system may allow for the operation of an HTML5 capable browser such as, for example, Opera, Internet Explorer, Safari, Chrome, Firefox, or others.

The source node (also referred to herein as a “Responder IQ serving site” or simply “Responder IQ”) may include of one or more web servers 616 and a database 618. The source node may also include one or more backup database servers for redundancy. Based at least in part on the server demand manifested by the clients as well as maintenance requirements, Responder IQ may include of one or more web servers 616. A web server 616 may include one or more processors, each of which may include one or more cores. A web server may include random access memory and may also include storage (e.g., a solid state drive, a hard disk, or some other storage). A web server 616 may be deployed with other equipment. For example, a web server 616 may be deployed behind a firewall or behind a filtering router. A web server may connect to the primary database server via a network switch. The database 618 may be deployed on a database server. The database server may store, provide, or organize the data associated with the system. The database server may include one or more processors, random access memory, and storage capacity (e.g., either solid state drive, hard disk, or some other storage). The web server 616 and the database server may each have an installed operating system as described herein. The database may be implemented using a database system including, but not limited to, Microsoft SQL, MySql, PostgreSQL, MariaDB, or some other database system.

It may be possible for a user to modify his mobile device such that it reports a position different from where the device is actually located. A user may wish to cloak his position for privacy or report a false position. For these reasons and perhaps others, the system may implement methods of position verification that the user may have difficulty falsifying. Using such methods, data provided by an untrusted device and/or source may be designated as trustworthy. For example, a user may call an emergency number and may make a voice report of a bomb explosion. Such an initial report may be without any burden of proof. The user may be asked to take a picture and forward it to the authorities, but a picture may be falsified as to its date, location, and content. In order to establish the position of a mobile device, the device may be directed to an input that may be corroborated by a like-sensing trusted device, or sense a set of data or events unknown a priori to the user and that are unable to be modified by the user. Methods wherein a device may be authenticated are described herein.

One method for authenticating a device may be when two devices view and record an image with sufficient levels of dynamic content (e.g., content that changes over time), the two devices may capture recordings that are sufficiently similar that one may conclude the two devices are in close proximity. The images may not render as exact duplicates, the objects captured may be sufficiently unique in space, time, and character that one may conclude the sensors (i.e., the mobile devices) are in the same or in a proximal location. For example, two devices side-by-side may image a busy sidewalk. The selected location may be sufficiently statically unique that an observer may conclude the whereabouts (e.g., in front of a well-known architecturally unique building). While the devices may not be in exactly the same physical location, the people on the sidewalk may be individually recognizable and may be considered unique as single objects and/or groups of objects in time and space. Based on visual inspection, an observer may determine whether the devices are indeed in the same place. If scene is sufficiently random, chaotic and irreversible, one may conclude the images were taken at nearly the same time and place, thus validating the claim of a device present at a specific location at a specific time. To further validate the claim, image processing and analysis techniques may be used to further assess the veracity of the claim depending on the sensing capabilities of each device, an analysis of the lighting conditions, chromatic distribution of the pixels, or other related mechanisms.

Another method of authenticating a device may be to provide a unique signal to a device that may only be received if the device is indeed in close proximity of the signal. If the device is able to receive the signal, one may conclude the device is indeed proximate to the signal. For example, a device may record a traffic light at a corner. If the city has awareness as to the traffic light status, the mobile device may be tasked to record a traffic light over a certain number of cycles. The user may then forward the recording of the traffic light for comparison to the known state of the traffic light over time. If the recording comports with the operation of the traffic light, the device may be verified to be in the vicinity of the traffic light. If the light is able to be modulated remotely, the traffic light operating authorities might also modify the light patterns and timing to further complicate the signal, thus providing a higher level of certainty that the device may be in the vicinity of the traffic light. A unique sound or random sound may also be emitted for the purpose of having the mobile device record and then submit the sound for comparison with the source.

As described herein, by arraying sensors based on their sensing and coverage area, a database of sensors may be queried for cases where a point or area intersects a sensor coverage area. In doing so, sensors may provide data based on their position. The sensors may also be repurposed dynamically in cases where the desired sensor does not provide coverage, but an alternative sensor does provide coverage. For example, a rain gage may not be available, but a camera may indicate the presence of rain. In another example, a system to detect power outage may not function, but a sensor operating at the same location may be adequate to determine if power is indeed available.

Under certain circumstances, there may be reason to solicit or accept data feeds from unauthenticated sensors (sensors that are “cast into” the system) by unauthenticated users. The data from such systems may be untrusted, however may be useful for a variety of purposes. For example, a mobile phone may be repurposed to relay the output from the microphone or the accelerometer of the mobile phone. When registered as an unauthenticated organization, the audio feed from one or more phones may be stored in the system along with the position data of those phones.

Using a database of position information, the system may be configured to determine if selected geometries (i.e., two dimensional and/or three dimensional volumes) intersect. Such geometries may be buffered to account for cases where two or more geometries (point, polygon, or volume) are to remain no closer than a particular distance (e.g. restraining order) or no further away that a certain distance (e.g. home detention). Adding data types and vectors to the geoposition data, an object of a certain character may be identified as to current position as well as velocity (constituted by direction and magnitude). Based on locating data, the object's future position, or the limits of its position over time, may be established based on current conditions such as its current position. Sensors may further be correlated to search for an object of interest thus creating the potential to fix the object's position at a future point in time or, alternatively, to eliminate areas where the object may be shown to not be.

By collecting and processing sensor data real-time, a signal and the time and position from whence it was received may be correlated with other sensors to create a synthetic, mobile sensing system. Collecting signals with a unique character or signature, the signal may be tracked across multiple sensing devices. Sound signatures may include, but may not be limited to, to sound (frequency), color, or light emission by wavelength. Using Doppler data, position analysis, and previous probable detections, an object may be tracked and archived. As an example, an airplane car or even bird may be tracked by mobile phone using the phone's microphone and position (provided there is sufficient signal to process over time). Likewise, a collection of devices (e.g., cell phones that are properly waterproofed) may be submerged to form a network to track fish and/or to track man-made objects.

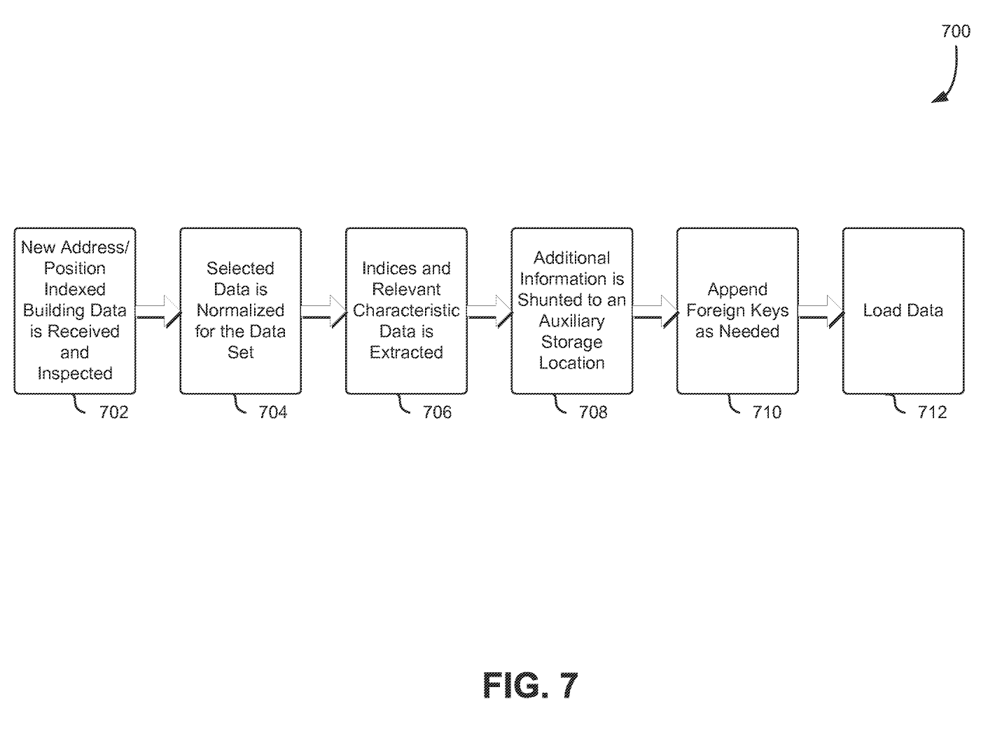

FIG. 7 illustrates an example data flow 700 in accordance with an embodiment. In the example data flow 700, new address or position indexed data building data may be received and inspected 702. The selected data may then be normalized for the data set 704. Indices and relevant characteristic data may then be extracted 706. Additional information may then be shunted to an auxiliary storage location 708. Foreign keys may then be appended to the data as needed 710. Finally, the data may be loaded 712 into the database. In the example illustrated in FIG. 7, the loading of static information into the system may undergo a process wherein the data elements that may be related to other data sets are indexed with relational information which may be retained in a database table. The relational information may be stored with the data elements. The relational information may also be separated and stored in one or more auxiliary tables.

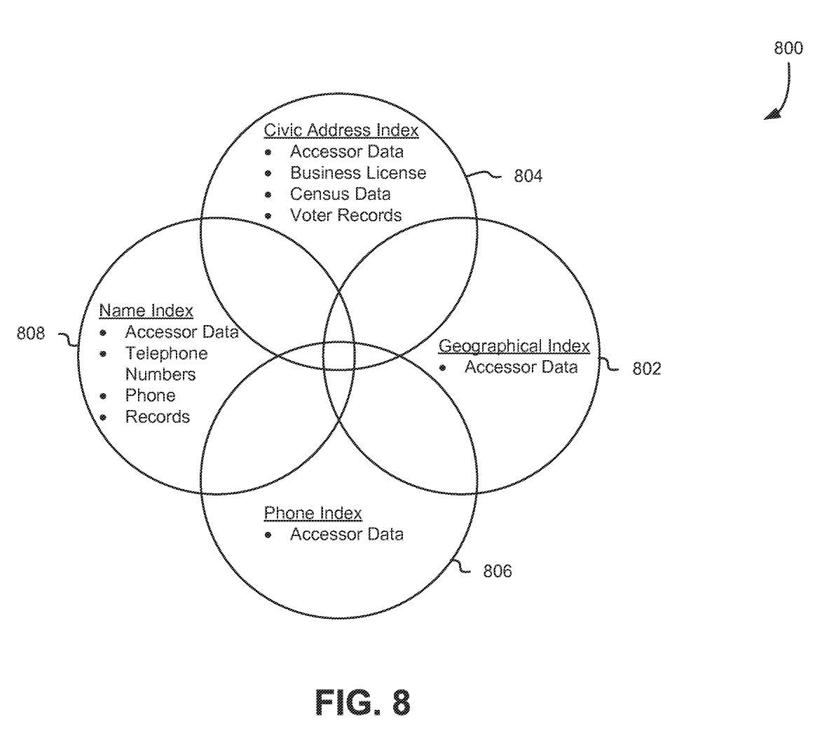

FIG. 8 illustrates an example data correlation 800 in accordance with an embodiment. In the example illustrated in FIG. 8, business licenses which may be indexed by address in a civic address index 804 may be related to the addresses of buildings using a name index 808, a geographical index 802, and/or a phone index 806.

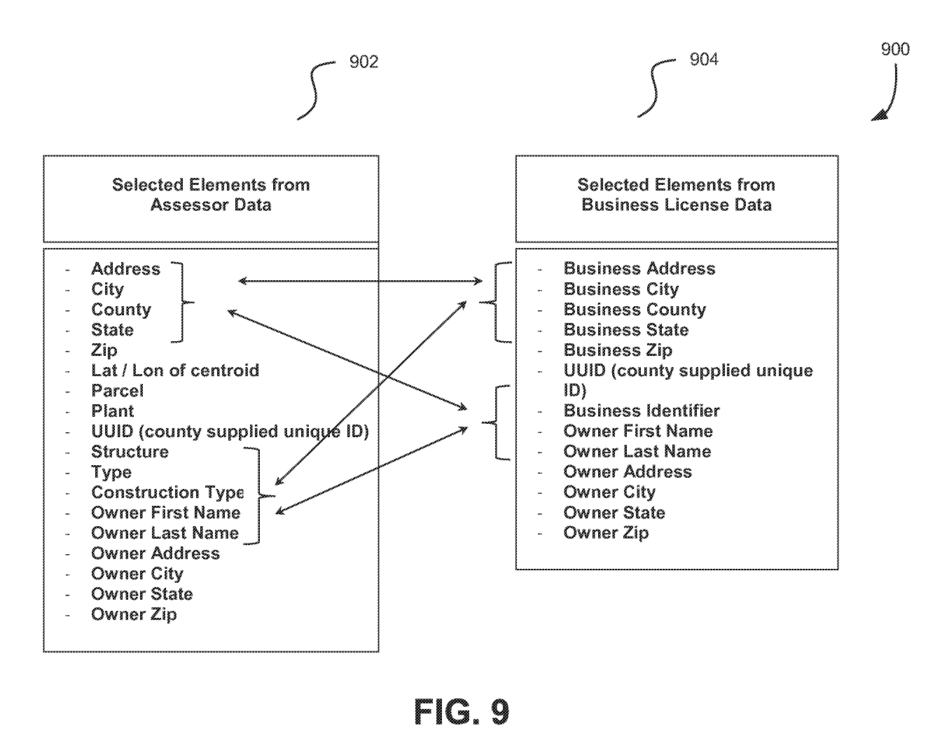

FIG. 9 illustrates an example relation of correlated data 900 in accordance with an embodiment. The example relation of correlated data illustrated in FIG. 9 shows excerpts from typical assessor data 902 and business license data 904. Each data set contains two references to addresses. In the case of assessor data 902, it is the address of the assessed property and the address of the owner. In the case of business license data 904, there is an address for the business location and the address of the owner. By correlating these addresses in different ways using the system, the system may be configured to make inferences regarding the property, the business, and the owners of each. With respect to the assessor data 902, if the address of a residence is the same as the address of the owner, it may be inferred that the owner lives at the property. Alternatively, if the address of the residence is not the same as the owner, it may be inferred that this is not the owner's primary residence. If a business address is the same as a residence and the business owner's address is the same as the residence address, it may be inferred that the business is run out of the owner's home. The act of relating various data may not only provide details related to a specific location or person, it may reveal a network of associated people, places, and things. These related data may assist in both emergency response as well as individual preparedness.

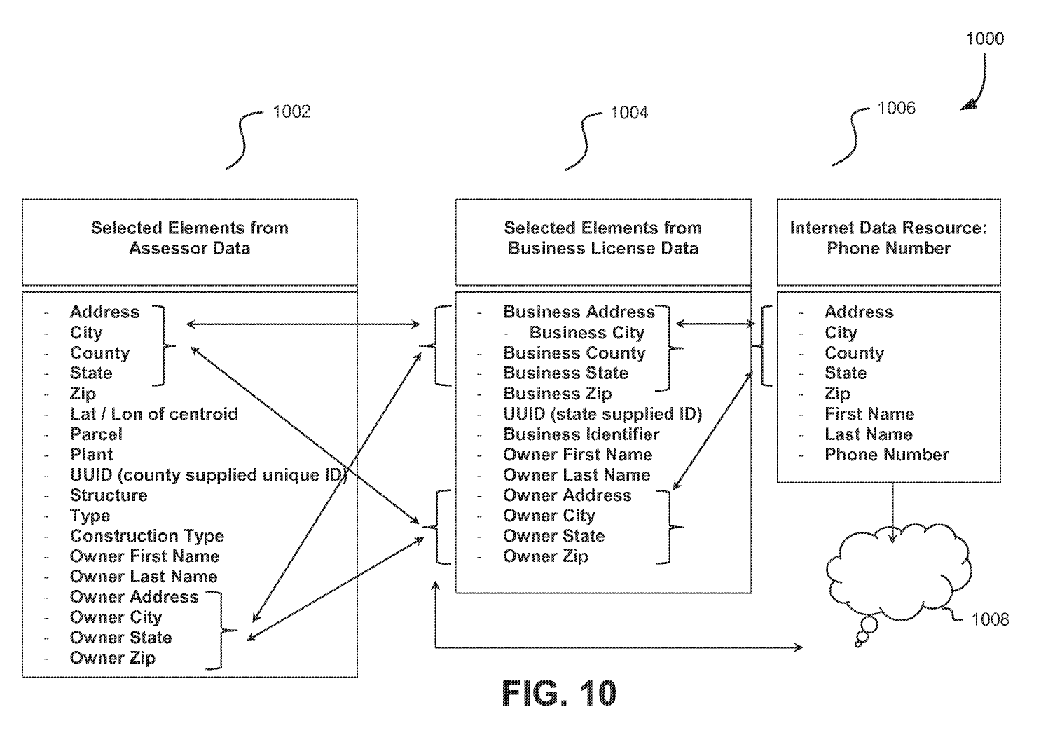

By extension, in cases where internet data resources are known to exist and may be correlated to information resident in the claimed system's database, an additional relation may be made to the internet data resources using an index, a transfer table, or a direct query to the internet data resources. FIG. 10 illustrates an example relation of correlated data 1000 in accordance with an embodiment where the assessor data 1002 and the business license data 1004 may be extended to include phone numbers 1006 by, for example, matching one or more addresses contained in the assessor data 1002 and/or the business license data 1004 using the internet data resources 1008.

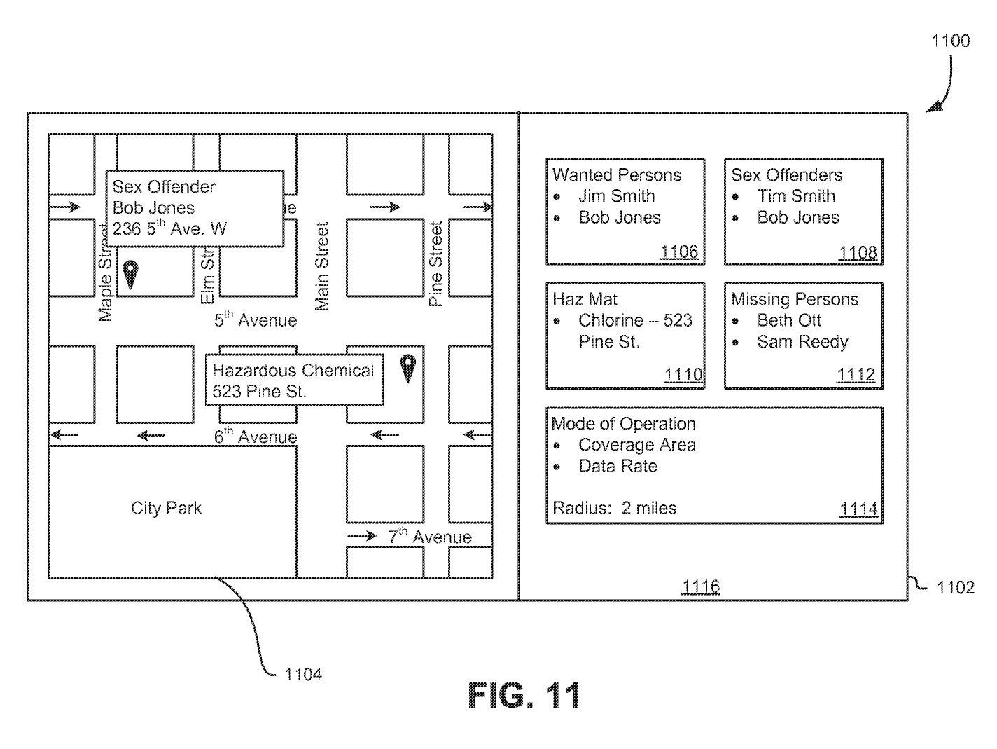

FIG. 11 illustrates an example environment 1100 where a map and alert display associated with a system for conveying data to responders and routing, reviewing and approving supplemental pertinent data as described herein in connection with FIG. 1 is displayed in accordance with an embodiment. The claimed system may be utilized in a variety of applications to include law enforcement, emergency response, medical assistance, search and rescue, parole officer interviews, and in-field support for case workers. For example, in a law enforcement context, while in the field, a law enforcement officer may be stationary or in transit. The officer's position (latitude and longitude) may be relayed to the system on a periodic basis. The system may then conduct a database and/or web search to identify, format and return hazards and other data near that reported position. The hazards may be plotted on a map which may be populated form a separate source (i.e., open street maps or MapQuest). As shown in FIG. 11, a client on the user's computer may aggregate inbound map and hazard data and plot each on the map as well as a data display.

If the officer is in motion, his position may be relayed more frequently than if stationary. In this way, the officer's velocity may impact the data rate needed to inform him of potential hazards in sufficient time to act on the information provided. Under this data refresh strategy, the officer may be presented with data at a rate that allows sufficient mental processing. In one mode of operation, the data rate may be based on ensuring that every known hazard within a defined radius may be conveyed to the officer within a certain amount of time. The higher the velocity of the officer, the larger the area that may be sampled (or “swept out”). The area swept out may be equal to a circle of defined radius translated by a distance based on speed and/or refresh interval. Alternately, a data refresh rate based on, for example, alerts per minute may be set. In a data rate implementation, alerts may be returned to the officer in order of proximity or in order of potential threat. Based on the officer's position, data may be returned based on a priority algorithm (e.g., proximity or threat) such that the rate is equal to the data limit. The data rate implementation may be further modified to restrict data to a particular geographic location or area about a selected point, which in turn can move over time

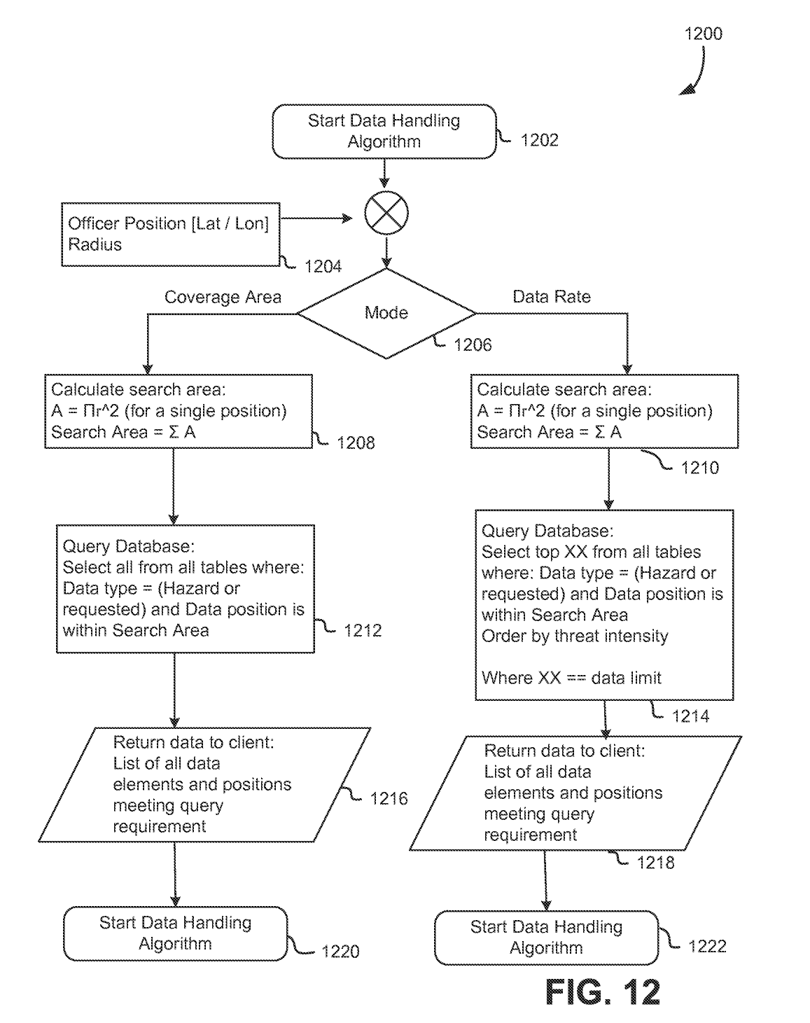

FIG. 12 illustrates an example data handling process 1200 for processing the data in accordance with an embodiment. The system may first start 1202 the data handling algorithm. An officer position 1204 may be input into the system as described herein. If the mode 1206 is a coverage area mode, the system may calculate a search area 1208, may query a database 1212, may return data to the client 1216, and may stop the data handling algorithm 1220. If the mode 1206 is a data rate mode, the system may calculate the search area 1210, may query the database 1214, may return the data to the client 1218, and may stop the data handling algorithm 1222.

Various details describing ancillary data regarding data points or information within the system or obtained via third party sources are described herein. The special instructions for any given data point may be related to, but may not be limited to, sensors, department of health, county assessor records, multi-tenant building data and other such items. The special instructions may encompass the related data and may convey procedures, methods, and courses of action, persons to contact, handling, public safety, and the like. The purpose of the special instructions is to inform the user of any information about a data point that may or may not be known prior to using the system or evident from data presented prior.

For example, if a responder is interacting with a felon, this user could use the system to identify any medical problems this person may or may not have. This could inform a decision whether or not if care is needed in apprehension due a heart condition the offender may have.

If a responder is dispatched to a residence which functions as a foster home, the system could inform the responder that not only are there children under care of foster parents, but perhaps one child suffers from extreme autism and can become combative when under duress. This information would allow a responder the ability to remove the child if necessary without endangering the child, other children, or themselves.

If a user/responder finds them in a situation where a chemical has inadvertently or deliberately been disbursed into the environment; evacuation, stand-off, treatment, safety zones, etc. can be conveyed via the special instructions for a given chemical. The user/responder can then use the instructions to safely evacuate and manage risks associated with the chemical and the environment which it was disbursed.

In the event that a responder is dispatched to an adult care facility and said facility houses Alzheimer patients. The special instructions could display information regarding severity, number of patients, and/or behaviors of said patients. It could also be utilized in the event that an Alzheimer patient has left the facility and is currently missing. In this scenario, a responder could be presented with a more generic set of instructions not specific to one particular patient, but characteristics that most or all Alzheimer patients exhibit. This could provide that responder with value information on how to conduct a search for the missing patient as well as possible areas of concern for the responder, patient, and/or the general public.

In an example data scenario related to special instructions a user may query the system for information about an Alzheimer patient and the different ways the special instructions may be delivered and presented to the user. This example illustrates a scenario in which the user wishes to obtain information about a specific patient. In the example, a responder is dispatched to an adult care facility and is informed that an Alzheimer patient has been combative and has barricaded themselves in a room in the facility. The responder is not given any other information and has no prior knowledge of the facility or the patients that reside within. A responder could query the system for the address prior to arriving or once on scene query the system based on his/her current location. Once the system has a location to begin a query, the information requested by the user (e.g., hospital locations or care facility locations) within a given radius may be sent to the user's device and displayed on a map for visual reference. The user may then identify the adult care facility and review the information. If the information about the residents of the facility is available, the responder will be presented with any special instructions for the facility and/or the patients that reside within. At this point the responder now has the ability to review any special instructions about the Alzheimer patient and can be prepared to deescalate the situation appropriately without causing harm to the patient, themselves, or any other staff or patients. In addition to the special instructions, the responder may be presented with additional information about the facility that may aide in the de-escalation of the situation

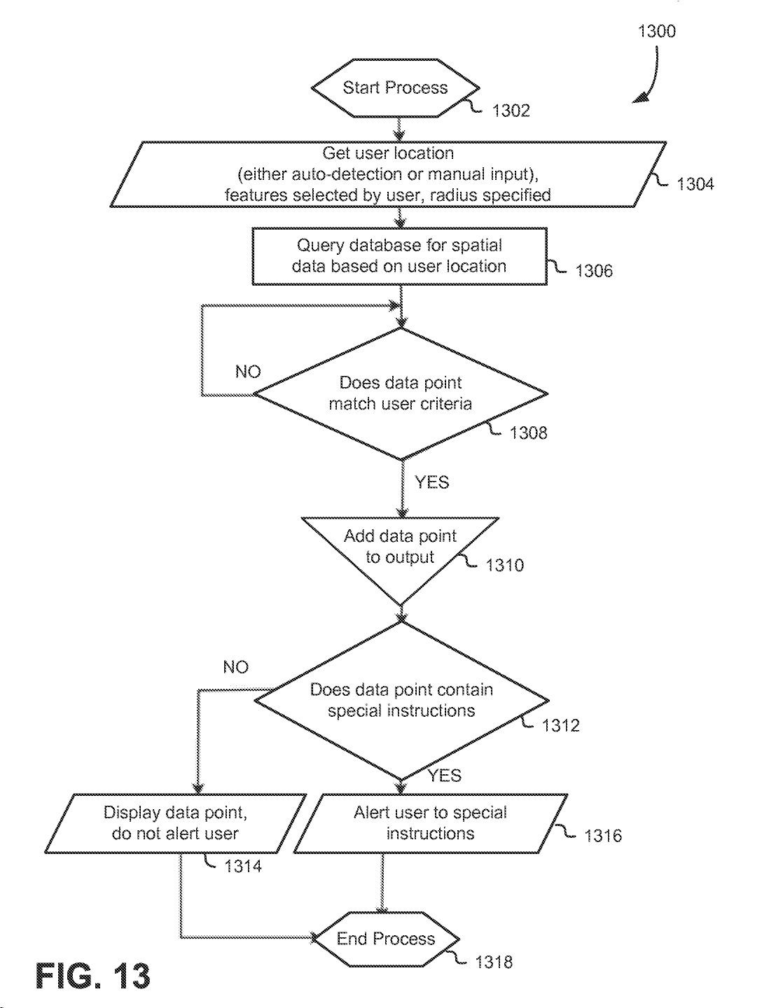

FIG. 13 illustrates an example process 1300 for conveying special instructions in accordance with an embodiment. In the example illustrated in FIG. 13, the process wherein the system for conveying data to responders and routing, reviewing and approving supplemental pertinent data determines relevant information related to the special instructions. The system may first start 1302 the process 1300 by determining the user location 1304. The system may then query the database 1306 and, based on whether the data point matches selection criteria 1308 may continue querying the database. If the data point matches selection criteria 1308, the system may add the data point to the output 1310. The system may then determine whether the data point contains special instructions 1312. If so, the system may alert the user to the special instructions 1316. If not, the system may display the data point and not alert the user 1314. The system may then end the process 1318.

Given a data element such as an address, phone number or name, related data may be identified and displayed in cases where a user wishes to understand how a particular person or entity is positioned and interacts with other networked elements. As an example, given an address, the database of the claimed system and associated internet data resources may be queried for all entities associated with that address. This may return persons who live at that location, those who own the location, those who conduct business at that location, and others who somehow are related to that location. The set of returned persons can then individually be applied to the database in search of related persons, locations, or entities. This process may be continued recursively between two data types (e.g., between name and address) or may recurse on all related data elements until a “NULL” return is obtained for each branch, or until a certain search depth has been obtained. A simple use case might occur when an unconscious person without any identification is found at a business location. Using chained data, a search may be conducted for all known phone numbers associated with that location. The list may include the unconscious person's phone number and may also include someone who might have knowledge of the person. To extend the data chain, the address may be used to match on business and assessor records for that site. The return may include a business license, all officers of the business, a building description, the building owner, and the building owner's address. The data chain may also be extended to include social media data where a reference to a business might return additional data including the business's internet domain, contact emails, phone numbers and points of contact for which the data recursion process could continue

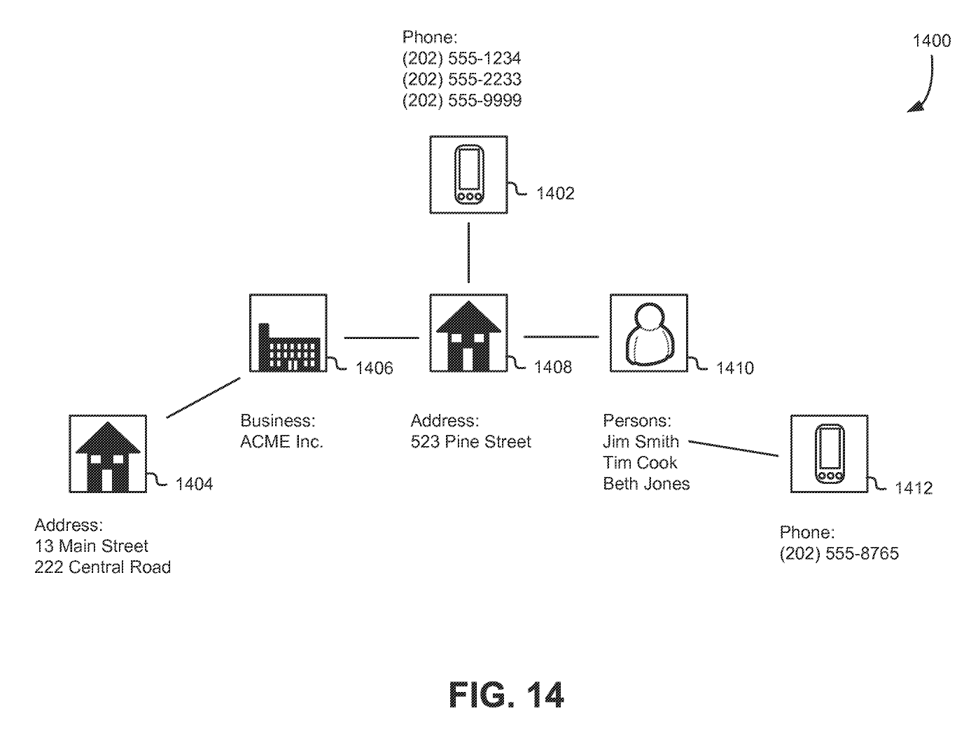

The data may be displayed as an array of vertices representing a data type (e.g., a phone number) and a specific data element (e.g., a specific phone number 202.555.1234). Each vertex may be connected to the other vertices by one or more undirected edges. The distance between nodes may be one or more hops. As illustrated in FIG. 14, the central node may be the data type and specific data element entered with all other nodes projected around the central search node. For example, in the example illustrated in FIG. 14, a central node 1408 corresponding to an address has a business node 1406, a people node 1410 (representing multiple people in this example), and a phone node 1402 (representing multiple phone numbers in this example) projected around it. The business node 1406 has an address node 1404 (indicating the address of the business). The people node 1410 has a phone node 1412 corresponding to the selected person (“Jim Smith”).

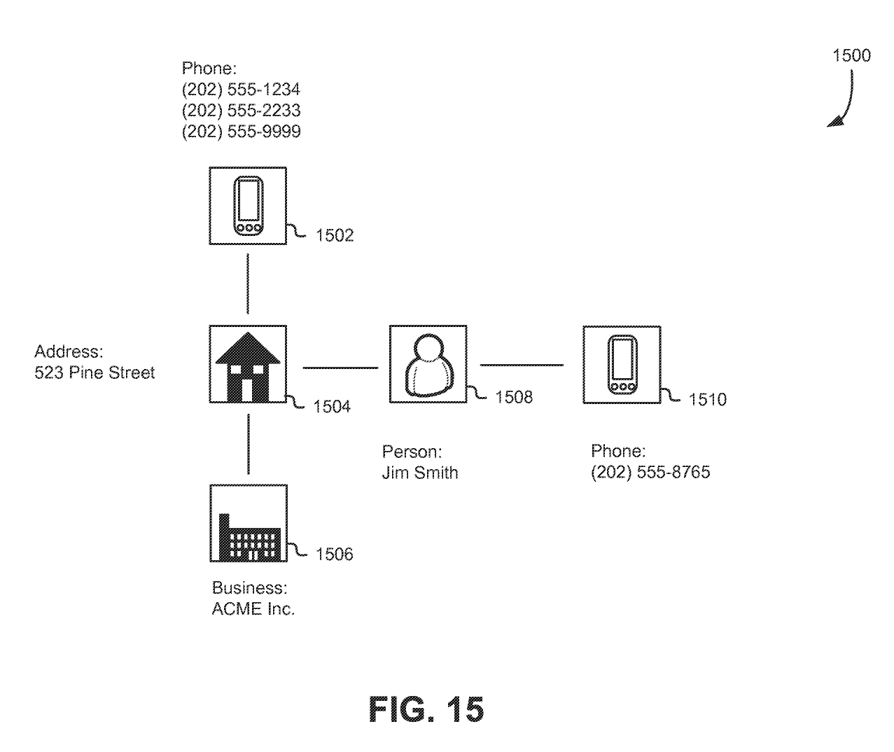

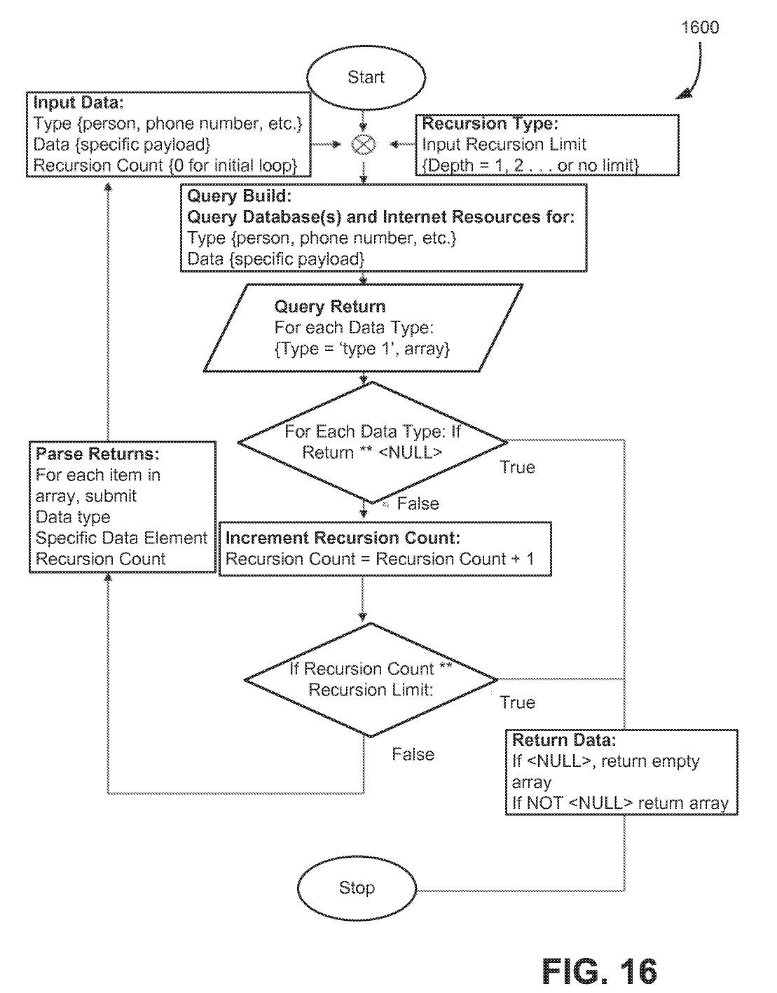

Selecting a new data element may cause the graph presentation to re-orient with the selected element in the center and nodes related to the central data element populated around the selected node as illustrated in FIG. 15. The central node 1504 corresponding to the address still has the business node 1506 and the phone node 1502, but the address of the business has been removed as it may not be relevant and the people node 1508 has been reduced to a single person of interest (“Jim Smith”). The phone node 1510 is retained as it relates to the person of interest. Details of data recursion described herein are illustrated by the process 1600 illustrated in FIG. 16.

Network attached sensors may provide ambient and situational awareness. As used herein, a sensor is defined as any device or process that may provide specialized or localized data in reference to its proximity. The data may be presented as close to real time as possible. These devices may be of special design such as a video camera or may be a more general computing device such as a workstation attached to some external apparatus. A sensor may also provide generalized information such as network or server status. Any information that may be collected and reported at a given point in time can be considered as a sensor source. Sensors may come in many forms including cameras, weather stations, time clocks, security systems, systems providing status information and other such forms. These devices may be of special design to provide a narrow view of some specific type of data. For example, cameras provide video information and may optionally transmit sound. Weather stations provide information such as temperature, wind speed and direction, humidity, barometric pressure, and solar radiation.

Sensors need not be stationary. Although many sensors are fixed at given location to provide information to that specific area they may also be mobile. An example of a mobile sensor might be an ankle bracelet attached to a person of interest. These mobile sensors may provide real time position of the person, a vehicle, or other real asset. Depending on the type of device other ambient information may be collected and reported such as, for example, device sensed speed and direction. Sensors may be registered in the database repository by their physical location (latitude and longitude). This allows their position to be reported to end users. Each registration may indicate the type of device the sensor represents. This allows the system to provide customized views of the sensor data. Additionally the network address and access method may be registered for the sensor. This allows the system to retrieve the actual sensor data. For many devices, only their location and type are registered in the database repository. The ambient data that these devices collect may be only made available to users on a pull/request type of query and thus may not be stored in the data repository.

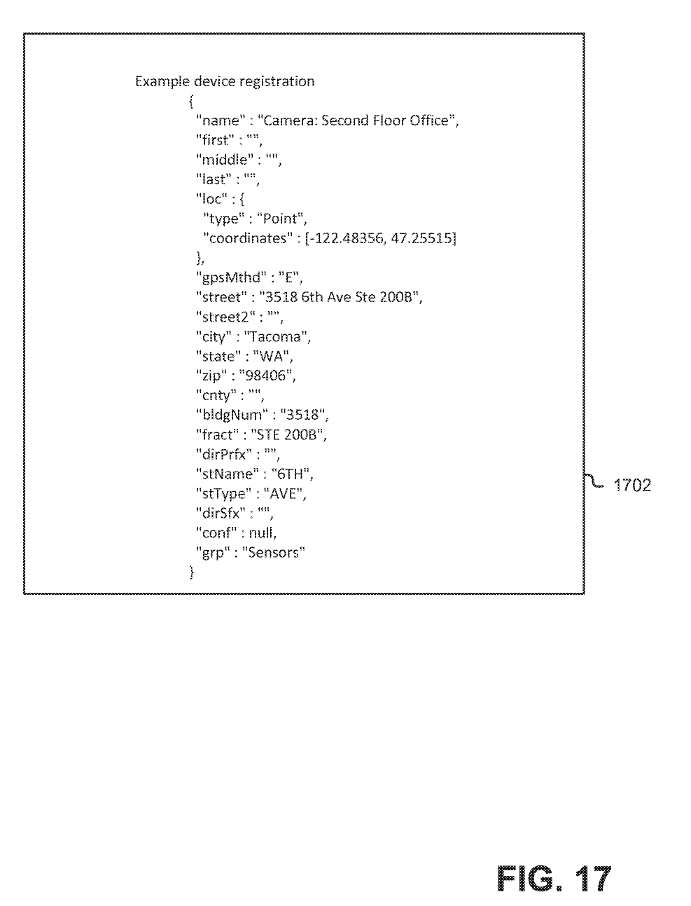

Additional metadata may be collected for each device registered. Information such as street address and contact information for the sensor may be recorded. This may help in the maintenance of the sensor registrations. This metadata may be extended depending on the type of sensor. An example would be for video cameras. On installation, video cameras may have a defined orientation and field of view which, in turn, may be referenced. More broadly, a list of geographic object within the field of view of the video camera may be registered and displayed on a map with the camera providing a visual representation of the data available via that sensor. This type of metadata can be extended to other types of sensors to provide a visual representation of their scope of presence as shown in the example device registration 1702 illustrated in FIG. 17.

A system user's current position may be considered a special class of sensor type. A user's smart device such as a phone may be used to gather their current position and, depending on the devices capabilities, may dynamically register its position in the data repository. Any other data that the device could gather such as video and sound, in the case of a smart phone may also be made available. Such a smart device may dynamically connect to the network and thus, this additional data collected may be registered in the data repository thus making reporting process timelier.

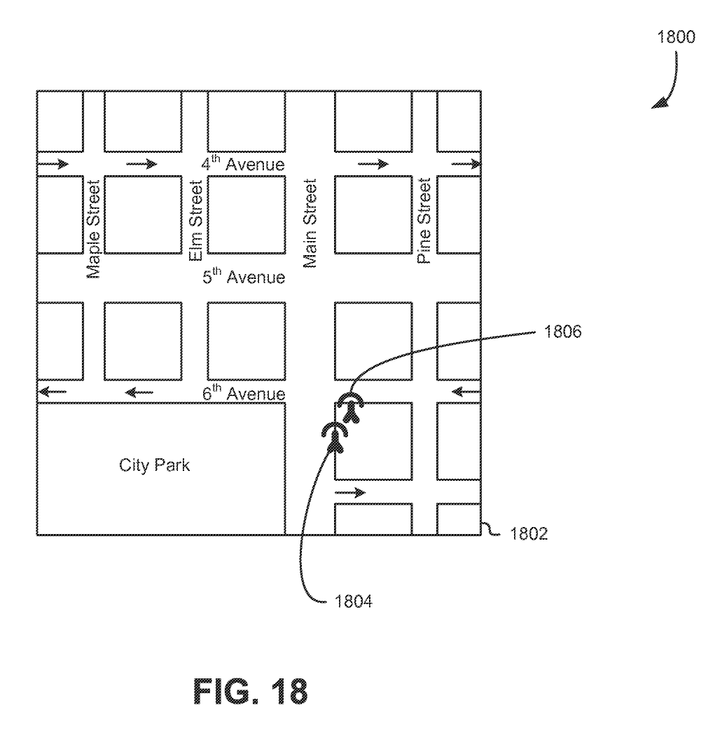

Many interfaces may be developed to allow the discovery of the geospatial data points representing the registered sensors. For a user in the field their current geographical position may be gathered through a device such as their smart phone, tablet, laptop, or other device. With this information the database repository may be queried for all registered sensors within a given area. The resulting sensor information may then be presented on a map in reference to the users position with each sensor positioned on the map accordingly. Once a sensor has been displayed on the map, the position of the sensor may be shown as a custom icon such as the custom icon 1804 or the custom icon 1806 displayed on the map 1802 as illustrated in FIG. 18.

In cases where the user is at a fixed location such as a 911 call center or dispatch office, the system may allow the user to search for a given location. The user may search based on an address, geolocation, business name, an individual's name or geographic area. Sensors may be further used to ascertain continuity of the path between two nodes such as the sensor and the querying location. If the sensor responds to query, the sensor location may be inferred to be operating normally. If the sensor is non-responsive, the path may be assumed to have been disrupted. Querying the sensor from one or many alternative paths may resolve ambiguity as to the location of the disruption.

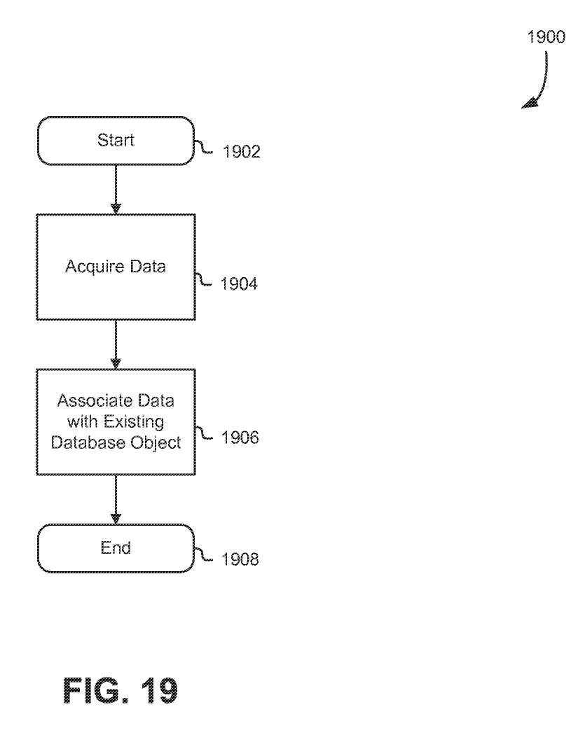

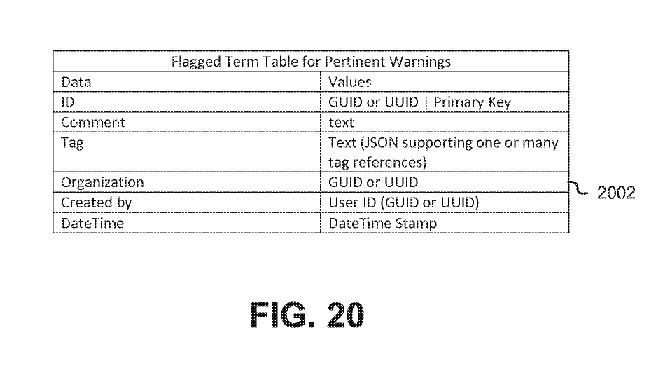

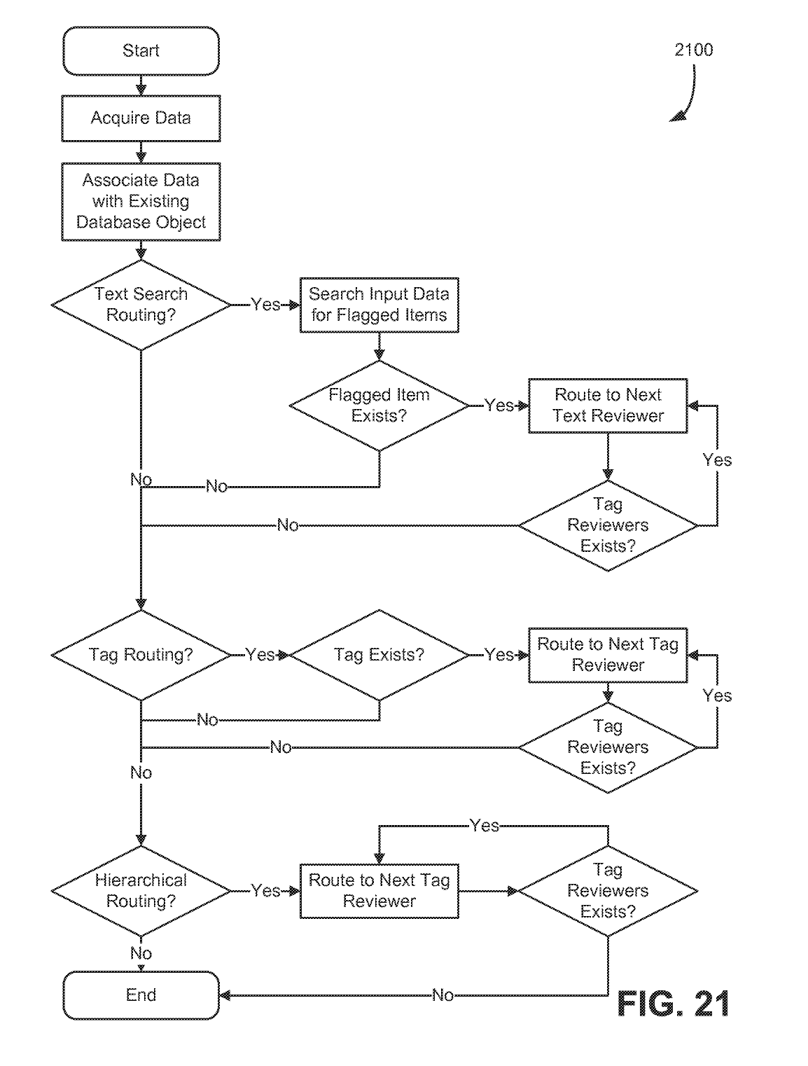

Data collected at a site or object of interest may be directly added as metadata to that object and made available for immediate use as described in the process 1900 illustrated in FIG. 19. The system may start the process 1902, may acquire data 1904, may associate data with an existing database object 1906, and may end the process 1908. The scheme associated with basic collection and storage of this data is illustrated in the flagged term table for pertinent warnings table 2002 illustrated in FIG. 20. In some embodiments, data may need to be reviewed for accuracy, clarity, normalization, and other operational considerations. When additional review is required, the system may route the collected data to one or many reviewers and/or approvers. The data may be routed by tag, operational chain of command or both. The system may additionally highlight certain free text words existing outside established tags. Should these words appear, additional routing may automatically take place as described in the process 2100 illustrated in FIG. 21.

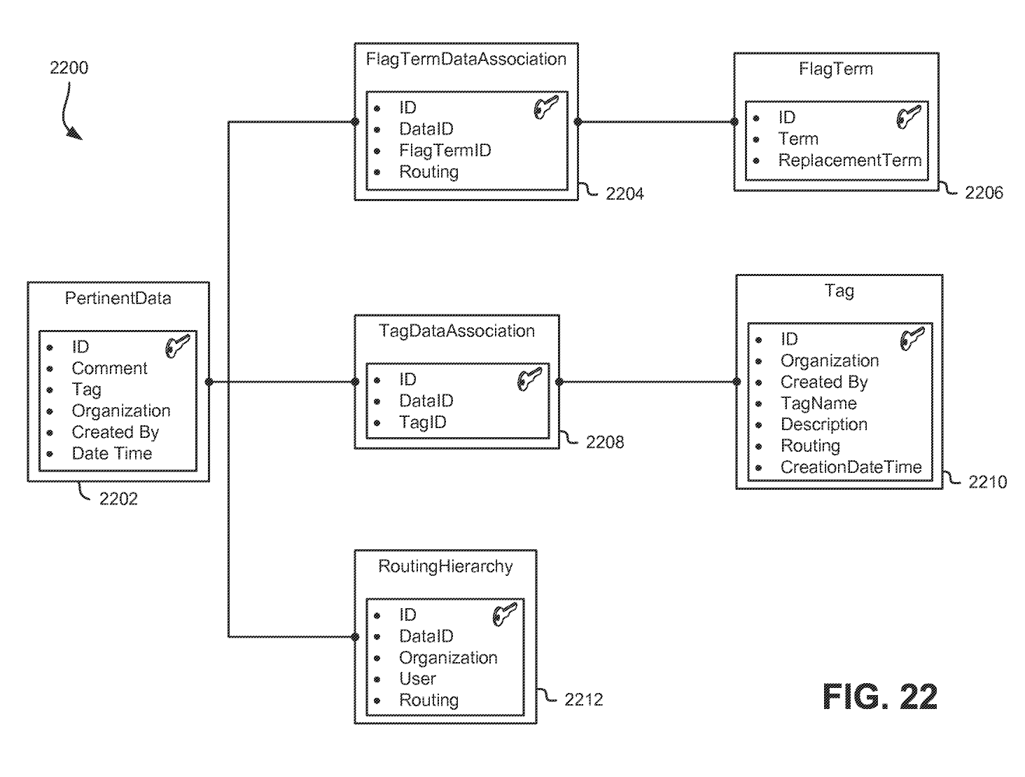

On configuring settings within the system, each organization may elect to enable additional routing of pertinent data such that there are intervening steps between the acquisition of a data element and its formal association with another data object. For example, a dog, which may be considered to be a hazard, may reside inside a house. With the house already documented in the database, the pertinent information to be associated with the house and retained as metadata may be the presence of a dog. In such an example, the system may perform one or more supervisory or conditional routing operations. As described herein, the three supervisory or conditional routing provisions are flagged term routing, tag routing, and hierarchical routing. Below is a description of each function. An overall data schematic of the three routing provisions is described in the data schematic 2200 illustrated in FIG. 22. The data schematic 2200 illustrated in FIG. 22 includes example data descriptions for PertinentData 2202, FlagTermDataAssociation 2204, TagDataAssociation 2208, RoutingHierarchy 2212, FlagTerm 2206, and Tag 2210 data.

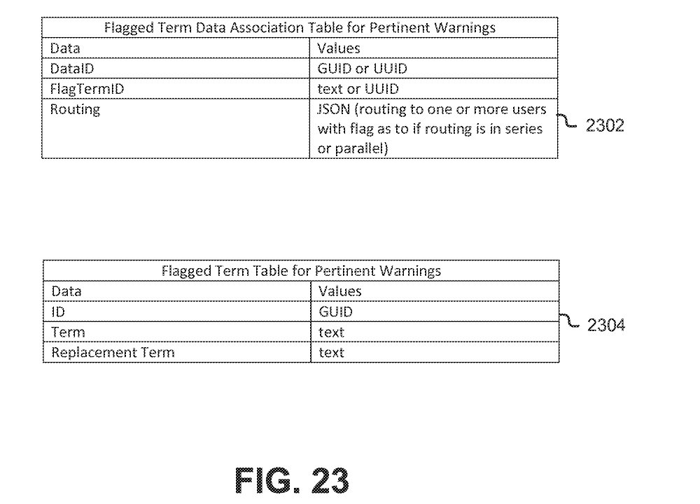

FIG. 23 illustrates example tables associated with flagged term routing in accordance with an embodiment. FIG. 23 illustrates an example flagged term data association table for pertinent warnings 2302 and an example flagged term table for pertinent warnings 2304. The flagged term routing provision may conduct a text search of the proposed pertinent information. If one or many flagged terms appears in the proposed pertinent information, flagged term routing may be activated. Once activated, proposed metadata is routed by the system to one or many reviewers for actions consistent with organizational policy. Reviewers may be notified by email of a pending flagged term and can also access a queue of flagged terms in the claimed system. On receipt, the reviewer may be presented with each flagged term and also may be presented with a proposed translation. Once reviewed, the proposed data may be progressed to the next stage.

Flagged term routing may be useful to resolve data ambiguities. Often different words may be used to describe the same situation. A redundant vocabulary may sometimes create confusion and additional context may be intended to resolve confusion. In order to develop a consistent lexicon, words that have multiple or confusions meanings may be added to the set of flagged terms. On detecting a word, the system may highlight its presence and may propose a normalized or standardized term. For example, the terms ‘dog’, ‘canine’ and ‘pit bull’ might be grouped as a set of flagged terms and all terms may be translated to ‘K9’. The flagged terms may also include those terms which might be considered to be inflammatory, imprecise, or otherwise not consistent with organizational policy.

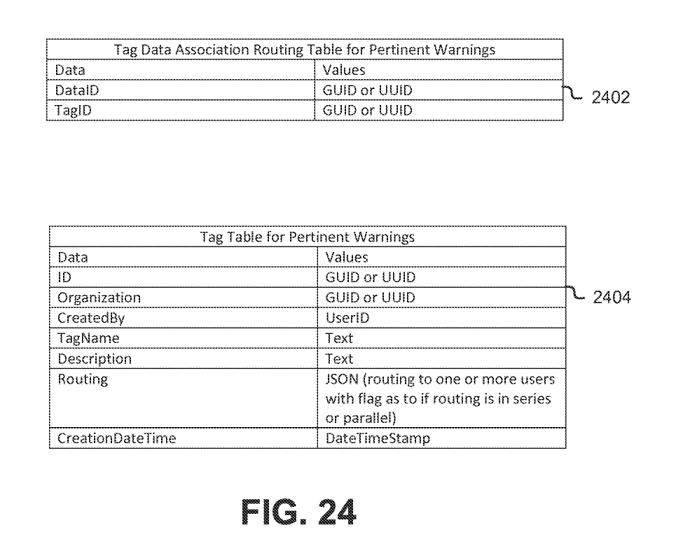

FIG. 24 illustrates example tables associated with tag routing in accordance with an embodiment. FIG. 24 illustrates an example tag data association routing table for pertinent warnings 2402 and an example tag table for pertinent warnings 2404. Tag routing may provide an additional review pathway for data. A tag may be an attribute of the pertinent data. Pertinent data may have zero, one, or many tags. For each tag, there may be zero, one, or many routing destinations. If pertinent data carries with it a tag and that tag has a routing requirement, each reviewer may be notified either in parallel or series by email or by accessing a queue of routed tags. On receipt, each reviewer may evaluate the need to take action consistent with organization policy. Once the tag has transited all reviews and has been approved, the proposed data may be progressed to the next stage.

Tag routing may be beneficial in cases where one or many people may have a need to be alerted as to a particular condition described by a tag. For example, if a possible violation of an animal control ordinance is observed as part of the pertinent data, an “Animal Control” tag may be added to the proposed data. In this case, the data may also be reviewed by the animal control division of the local law enforcement agency.

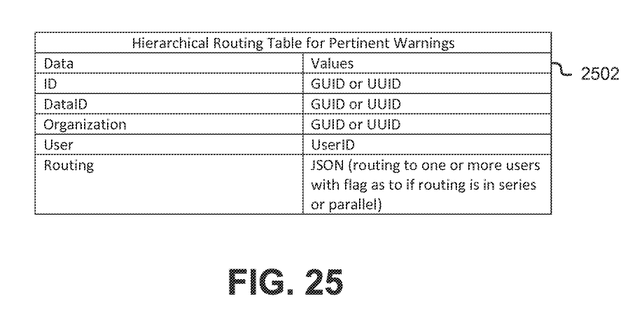

FIG. 25 illustrates an example table associated with hierarchical routing in accordance with an embodiment. FIG. 25 illustrates an example hierarchical routing table for pertinent warnings 2502. Hierarchal routing may be used to forward propose pertinent data through a supervisory pathway. The data may be routed sequentially through an approval path identified for each user. If pertinent, data may then be routed to each reviewer and approver in a defined order. Each reviewer may be notified by email or accessing their hierarchal routing queues in the claimed system. On receipt, each reviewer may evaluate the need to take action consistent with organization policy. Prior to being added to the record, data may be evaluated for agency awareness, operational value, and informational accuracy. Using hierarchal routing, an agency may ensure it remains aware of all metadata associated with existing data.

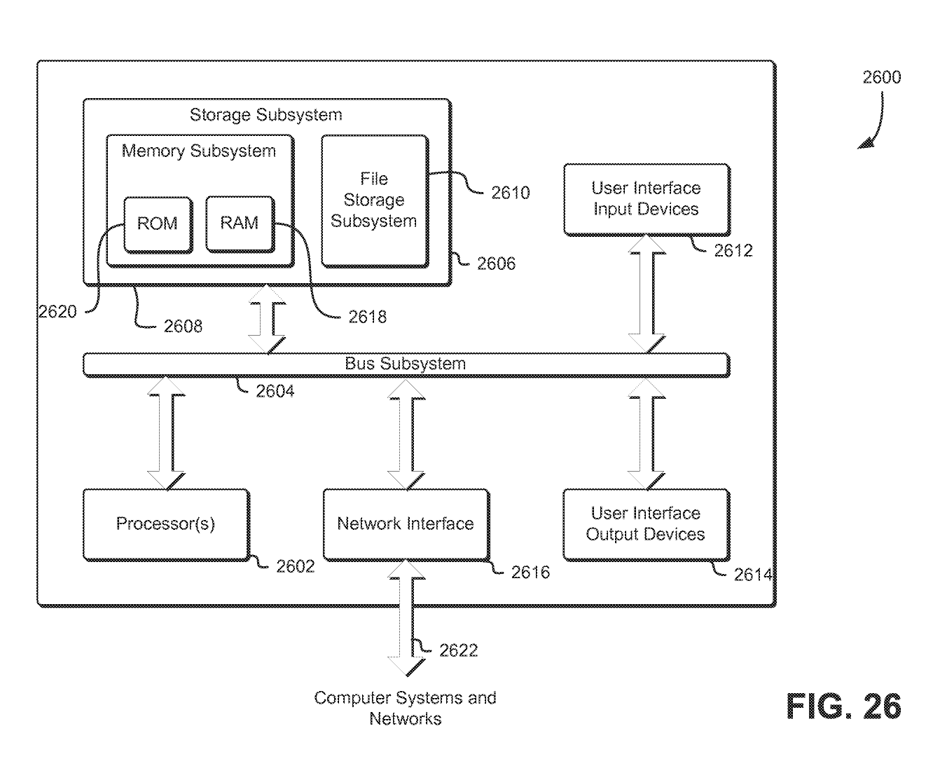

FIG. 26 is a simplified block diagram of a computer system 2600 that may be used to practice an embodiment of the present invention. In various embodiments, the computer system 2600 may be used to implement any of the systems illustrated and described above. For example, the computer system 2600 may be used to implement processes associated with a system for conveying data to responders and routing, reviewing and approving supplemental pertinent data according to the present disclosure. As shown in FIG. 26, the computer system 2600 may include one or more processors 2602 that may be configured to communicate with and are operatively coupled to a number of peripheral subsystems via a bus subsystem 2604. These peripheral subsystems may include a storage subsystem 2606, comprising a memory subsystem 2608 and a file storage subsystem 2610, one or more user interface input devices 2612, user interface output devices 2614, and a network interface subsystem 2616.

The bus subsystem 2604 may provide a mechanism for enabling the various components and subsystems of computer system 2600 to communicate with each other as intended. Although the bus subsystem 2604 is shown schematically as a single bus, alternative embodiments of the bus subsystem may utilize multiple busses.

The network interface subsystem 2616 may provide an interface 2622 to other computer systems and networks. The network interface subsystem 2616 may serve as an interface for receiving data from and transmitting data to other systems from the computer system 2600. For example, the network interface subsystem 2616 may enable a user computer system device to connect to the computer system 2600 via the Internet and/or other network, such as a mobile network, and facilitate communications using the network(s).

The user interface input devices 2612 may include a keyboard, pointing devices such as a mouse, trackball, touchpad, or graphics tablet, a scanner, a barcode scanner, a touch screen incorporated into the display, audio input devices such as voice recognition systems, microphones, and other types of input devices. Further, in some embodiments, input devices may include devices usable to obtain information from other devices, such as retrieving sensor data. Input devices may include, for instance, magnetic or other card readers, one or more USB interfaces, near field communications (NFC) devices/interfaces and other devices/interfaces usable to obtain data from other devices. In general, use of the term “input device” is intended to include all possible types of devices and mechanisms for inputting information to the computer system 2600.

The user interface output devices 2614 may include a display subsystem, a printer, or non-visual displays, such as audio and/or tactile output devices, and other such devices. Generally, the output devices 2614 may invoke one or more of any of the five senses of a user. For example, the display subsystem may be a cathode ray tube (CRT), a flat-panel device, such as a liquid crystal display (LCD), light emitting diode (LED) display, or a projection or other display device. In general, use of the term “output device” is intended to include all possible types of devices and mechanisms for outputting information from the computer system 2600. The output device(s) 2614 may be used, for example, to generate and/or present user interfaces to facilitate user interaction with applications performing processes described herein and variations therein, when such interaction may be appropriate. While a computer system 2600 with user interface output devices is used for the purpose of illustration, it should be noted that the computer system 2600 may operate without an output device, such as when the computer system 2600 is operated in a server rack and, during typical operation, an output device is not needed.

The storage subsystem 2606 may provide a computer-readable storage medium for storing the basic programming and data constructs that provide the functionality of the present invention. Software (programs, code modules, instructions) that, when executed by one or more processors 2602, may provide the functionality of the present invention, may be stored in storage subsystem 2606. The storage subsystem 2606 may also provide a repository for storing data used in accordance with the present invention. The storage subsystem 2606 may comprise memory subsystem 2608 and file/disk storage subsystem 2610. The storage subsystem may include database storage for the situational data, file storage for sensor data, and/or other storage functionality.

The memory subsystem 2608 may include a number of memory devices including, for example, random access memory (RAM) 2618 for storage of instructions and data during program execution and read-only memory (ROM) 2620 in which fixed instructions may be stored. The file storage subsystem 2610 may provide a non-transitory persistent (non-volatile) storage for program and data files, and may include a hard disk drive, a floppy disk drive along with associated removable media, a compact disk read-only memory (CD-ROM) drive, a digital versatile disk (DVD), an optical drive, removable media cartridges, and other like storage media.

The computer system 2600 may be of various types including a personal computer, a portable computer, a workstation, a network computer, a mainframe, a kiosk, a server, or any other data processing system. Due to the ever-changing nature of computers and networks, the description of computer system 2600 depicted in FIG. 26 is intended only as a specific example for purposes of illustrating the preferred embodiment of the computer system. Many other configurations having more or fewer components than the system depicted in FIG. 26 are possible.

The various embodiments further can be implemented in a wide variety of operating environments, which in some cases can include one or more user computers, computing devices or processing devices which can be used to operate any of a number of applications. User or client devices may include any of a number of general purpose personal computers, such as desktop, laptop or tablet computers running a standard operating system, as well as cellular, wireless and handheld devices running mobile software and capable of supporting a number of networking and messaging protocols. Such a system may also include a number of workstations running any of a variety of commercially-available operating systems and other known applications for purposes such as development and database management. These devices may also include other electronic devices, such as dummy terminals, thin-clients, gaming systems and other devices capable of communicating via a network. These devices may also include virtual devices such as virtual machines, hypervisors and other virtual devices capable of communicating via a network.

Various embodiments of the present disclosure may utilize at least one network that would be familiar to those skilled in the art for supporting communications using any of a variety of commercially-available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and AppleTalk. The network can be, for example, a local area network, a wide-area network, a virtual private network, the Internet, an intranet, an extranet, a public switched telephone network, an infrared network, a wireless network, a satellite network, and any combination thereof.

In embodiments utilizing a web server, the web server may run any of a variety of server or mid-tier applications, including Hypertext Transfer Protocol (“HTTP”) servers, FTP servers, Common Gateway Interface (“CGI”) servers, data servers, Java servers, Apache servers, and business application servers. The server(s) may also be capable of executing programs or scripts in response to requests from user devices, such as by executing one or more web applications that may be implemented as one or more scripts or programs written in any programming language, such as Java®, C, C# or C++, or any scripting language, such as Ruby, PHP, Perl, Python or TCL, as well as combinations thereof. The server(s) may also include database servers, including without limitation those commercially available from Oracle®, Microsoft®, Sybase®, and IBM® as well as open-source servers such as MySQL, Postgres, SQLite, MongoDB, and any other server capable of storing, retrieving, and accessing structured or unstructured data. Database servers may include table-based servers, document-based servers, unstructured servers, relational servers, non-relational servers or combinations of these and/or other database servers.

The environment may include a variety of data stores and other memory and storage media as discussed above. These may reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (“CPU” or “processor”), at least one input device (e.g., a mouse, keyboard, controller, touch screen or keypad) and at least one output device (e.g., a display device, printer or speaker). Such a system may also include one or more storage devices, such as disk drives, optical storage devices and solid-state storage devices such as random access memory (“RAM”) or read-only memory (“ROM”), as well as removable media devices, memory cards, flash cards, etc.

Such devices may also include a computer-readable storage media reader, a communications device (e.g., a modem, a network card (wireless or wired), an infrared communication device, etc.), and working memory as described above. The computer-readable storage media reader may be connected with, or configured to receive, a computer-readable storage medium, representing remote, local, fixed and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer-readable media for containing code, or portions of code, can include any appropriate media known or used in the art, including storage media and communication media, such as, but not limited to, volatile and non-volatile, removable and non-removable media implemented in any method or technology for storage and/or transmission of information such as computer-readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset”, unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A system, comprising: a database of sex offender addresses and identities and one or many additional separate databases or data service, such as phone, assessor, voter records, employment data, or tax record, or any other like record, which contain names and addresses of people in the same geographic area as the sex offenders; and a computing device configured to join the sex offender address data on the separate database or data service address data to reveal if the sex offender appears in an unrelated database as having the same address, the computing device further configured to provide an indication whether the sex offender administratively appears to be at that address.

2. A system comprising: a database of at-risk people such as foster children, senior citizens, developmentally disabled, handicapped, or similarly situated people, a position location system such as a mobile phone, tablet, notebook computer, GPS receiver, or a manual positioning method; and a computing device configured to receive a user's position or a position input, and indicate if there are complicating factors associated with the handling of an emergency response call, call for service or an interaction at that location by a case manager, social worker, medical provider or similar service provider.

3. A system comprising: a database of addresses of parolees, people with outstanding arrest warrants, or other factors which may create a risk to emergency responders or service providers, and a position location system such as a mobile phone, tablet, notebook computer, GPS receiver, or a manual positioning method; and a computing device configured to receive a user's position or a position input, and indicate if there are hazards or complicating factors associated with interacting with people or conditions present in the handling of an emergency response call, call for service or an interaction at that location by a case manager, social worker, medical provider or similar service provider.

4. A system comprising: a database of hazards or potential risks, which may be of human origin or caused by physical conditions present or potentially present at an address, which present or have the potential to present a hazard to emergency responders or service providers, and a position location system such as a mobile phone, tablet, notebook computer, GPS receiver, or a manual positioning method; and a computing device configured to receive a user's position or a position input, and indicate if the responder or service provider has the potential to be presented with hazards or complicating factors associated with interacting with people or conditions present in the handling of an emergency response call, call for service or an interaction at that location by a case manager, social worker, medical provider or similar service provider.

5. A system comprising: a database of addresses of all buildings and structures, a database of all businesses, and a position location system such as a mobile phone, tablet, notebook computer, GPS receiver, or a manual positioning method; and a computing device configured to receive a user's position or a position input, and indicate the nature of the business being conducted at a particular address and by extension the potential risks associated with conducting various operations at that location in the presence of that business or businesses.

6. The system of claim 5 further comprising a database of chemicals which can pose a risk to occupants of the location where they are stored, nearby humans, animals or property, or which may create a danger if certain emergency operations were undertaken.

7. The system of claim 5 further comprising a database which can accept related data or metadata as it pertains to a particular address, object or person, the system further configured to alert a responder if the responder are near or are about to come into contact with a location where data may pertain to their operations.

8. The system of claim 5 further comprising a data tag that can be assigned consistent meaning by an agency or a meaning shared across many agencies or organizations; and, given a comment, the data tag is also assigned and stored in a database to allow binary searching as to if one or many tagged conditions exist.

9. The system of claim 7 further comprising a comment searching and routing pathway to include a term or word specific database and an information routing path for each term; and given the appearance of a term in a comment or string, the entire comment describing a location, person or object, is forwarded to one or many persons for review and action consistent with the routing path.

10. The system of claim 9 further comprising a routing path which can be transited in series, parallel or a combination of each thus allowing for n-layers of routing and review complexity.

11. The system of claim 5 further comprising a data tag routing pathway; and given the appearance of a data tag associated with a comment or string, the entire comment describing a location, person, or object, is forwarded to one or many persons for review and action consistent with the routing path.

12. The system of claim 11 further comprising a routing path which can be transited in series, parallel or a combination of each thus allowing for n-layers of routing and review complexity.

13. The system of claim 5 further comprising a user-based routing pathway; and given the addition of a comment, the entire comment describing a location, person, or object, is forwarded to one or many persons for review and action consistent with the routing path.

14. The system of claim 13 further comprising a routing path which can be transited in series, parallel or a combination of each thus allowing for n-layers of routing and review complexity.

15. The system of claim 14 further comprising a routing path which can be transited in series, parallel or a combination of each based on the identity of the comment's originator.

16. The system of claim 7 further comprising one or more databases describing names of people as referenced by address, the one or more databases configured to be queried for the address associated with the comment data, the one or more databases updated for new information and then queried to determine if any of the data changed from the original query conducted when the comment was originated; and upon an indication that data has changed, providing an indication that the original comment may no longer be valid and that the comments are subject for review.
